(19) United States
(12) Patent Application Publication
(10) Pub. No.: US 2026/0352353 A1
(43) Pub. Date: Nov. 5, 2026

(54) VALIDATION OF ARTIFICIAL INTELLIGENCE (AI)/MACHINE LEARNING (ML) IN BEAM MANAGEMENT AND HIERARCHICAL BEAM PREDICTION

(71) Applicant: INTERDIGITAL PATENT HOLDINGS, INC., Wilmington, DE (US)

(72) Inventors: Nazli Khan Beigi, Longueuil (CA); Young Woo Kwak, Woodbury, NY (US); Patrick Tooher, Montreal (CA); Yugeswar Deenoo, Chalfont, PA (US); Moon IL Lee, Melville, NY (US); Tejaswinee Lutchoomun, Montreal (CA); Prasanna Herath, Laval (CA)

(73) Assignee: INTERDIGITAL PATENT HOLDINGS, INC., Wilmington, DE (US)

(21) Appl. No.: 19/100,166

(22) PCT Filed: Aug. 4, 2023
(86) PCT No.: PCT/US2023/029473

§ 371 Date: Jan. 31, 2025

Related U.S. Application Data
(60) Provisional application No. 63/395,587, filed on Aug. 5, 2022.

(51) Int. Cl. H04B 17/373; H04B 7/0417; H04L 5/00; H04W 24/10; H04W 72/044; H04W 72/0453

(52) U.S. Cl. CPC H04B 17/373; H04B 7/0417; H04L 5/0051; H04W 24/10; H04W 72/0453; H04W 72/046

(57) ABSTRACT

A wireless transmit/receive unit (WTRU) may perform measurements on a first set of beam resources. The WTRU may then predict beam resources in a second set of beam resources based on the measurements on the first set of beam resources. Further, the WTRU may report the predicted beam resources. Moreover, the WTRU may receive one or more first signals using a first beam. In an example, the first beam may use beam resources in the second set of beam resources. Also, the WTRU may perform measurements on one or more accuracy parameters of the received one or more first signals. Further, on a condition that the measured one or more accuracy parameters of the received one or more first signals are acceptable, the WTRU may transmit one or more second signals using the first beam.

### CROSS REFERENCE TO RELATED APPLICATION

This application claims the benefit of U.S. Provisional Application No. 63/395,587, filed Aug. 5, 2022, the contents of which are incorporated herein by reference.

### BACKGROUND

Beam management is a target use case for artificial intelligence (AI)/machine learning (ML) for the air interface in wireless communications. This technology could be the great foundation in improving performance and complexity in conventional beam management aspects, including beam prediction in time, and/or spatial domain for overhead and latency reduction, beam selection accuracy improvement, and so forth.

In wireless communications, conventional beam selection is based on beam sweeping at the gNode B (gNB)-side, or base station side, and wireless transmit/receive unit (WTRU)-side, or handset side. In frequency range 2 (FR2), conventional beam management could result in beam sweeping and measurement over large number of antennas at the gNB side and the WTRU side. Upon selection of the best beams, the WTRU can report up to four beams in a beam management procedure. In an example, the WTRU may report the beams based on reference signal received power (RSRP).

Using AI/ML models, FR2 beam selection/prediction can be performed based on frequency range 1 (FR1) channel state information (CSI) measurements. However, the realization of such a framework is subject to resolving the key challenges in beams' measurement and reporting as well as training and validation of the AI/ML model in scenarios with hierarchical spatial relations and associations between beam resources in different frequency ranges. Moreover, using of AI/ML model-based beam prediction may not be always beneficial. As an instance, in case of non-line of sight (NLOS) communications, AI/ML based beam prediction may be inaccurate and traditional beam management procedure would be beneficial.

### SUMMARY

A wireless transmit/receive unit (WTRU) may determine one or more beam resources based on measurements made on other beam resources. The measured beam resources may be frequency range 1 (FR1) beam resources and the determined beam resources may be frequency range 2 (FR2) beam resources. The determination may be based on an artificial intelligence (AI)/machine learning (ML) model. The WTRU may receive a signal using the one or more determined FR2 beam resources. Further, the WTRU may perform validation procedures based on one or more accuracy parameters.

In an example, a WTRU may perform measurements on a first set of beam resources. The WTRU may then predict beam resources in a second set of beam resources based on the measurements on the first set of beam resources. Further, the WTRU may report the predicted beam resources. Moreover, the WTRU may receive one or more first signals using a first beam. In an example, the first beam may use beam resources in the second set of beam resources. Also, the WTRU may perform measurements on one or more accuracy parameters of the received one or more first signals. Further, on a condition that the measured one or more accuracy parameters of the received one or more first signals are acceptable, the WTRU may transmit one or more second signals using the first beam. The accuracy parameters may be acceptable when a measured LOS is higher than an LOS threshold and a CQI is higher than a CQI threshold, in an example.

In a further example, the WTRU may receive one or more third signals using the first beam, on a condition that the measured one or more accuracy parameters of the received one or more first signals are acceptable.

In an example, the received one or more first signals may be a physical downlink control channel (PDCCH) signal. In another example, the received one or more first signals may be a channel state information-reference signal (CSI-RS).

Moreover, using the first beam may include activating the first beam, in an example. In another example, using the first beam may include continuing to use the first beam.

In a further example, the one or more accuracy parameters may include one or more of a line of sight (LOS) parameter, a channel parameter, or a channel quality indicator (CQI) parameter. In an additional example, the WTRU may also activate an AI/ML model to predict one or more second beams. The one or more second beams may use beam resources in the second set of beam resources, in an example. In an additional or an alternative example, the WTRU may continue to use the AI/ML model to predict one or more second beams.

In an additional example, the WTRU may transmit a request to select and report a third beam, on a condition that the measured one or more accuracy parameters of the received one or more first signals are not acceptable. The measured LOS may be lower than an LOS threshold and the measured CQI may be lower than a CQI threshold, in an example.

In another example, the WTRU may transmit a request on a condition that the measured one or more accuracy parameters of the received one or more first signals are not acceptable. In an example, the measured LOS may be higher than an LOS threshold and the measured CQI may be lower than a CQI threshold. The transmitted request may include a request to update an AI/ML model. The transmitted request may include a request to retrain the AI/ML model. Further, the transmitted request may include a request to use the AI/ML model to predict and report a fourth beam.

Moreover, the WTRU may fall back to a non-AI/ML beam management procedure to select and report a fifth beam, on a condition that the measured one or more accuracy parameters of the received one or more first signals are not acceptable. In an example, the measured CQI may be lower than a CQI threshold, and a number of time instances may have passed since the reception of the first signals using the first beam.

In a further example, the WTRU may receive one or more fourth signals using one or more sixth beams, and may measure one or more accuracy parameters of the received one or more fourth signals, on a condition that the measured one or more accuracy parameters of the received one or more first signals are not acceptable. In an example, the measured LOS may be lower than an LOS threshold, the measured CQI may be lower than a CQI threshold, and a number of time instances may have not passed since the reception of the first signals using the first beam.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example of beam prediction in a second set of beam resources based on a beam resources report in a first set of beam resources;

FIG. 3 is a flowchart diagram illustrating an example of a validation procedure for beam prediction based on hierarchical spatial relations; and

FIG. 4 is a flowchart diagram illustrating an example of predicted beam management.

### DETAILED DESCRIPTION

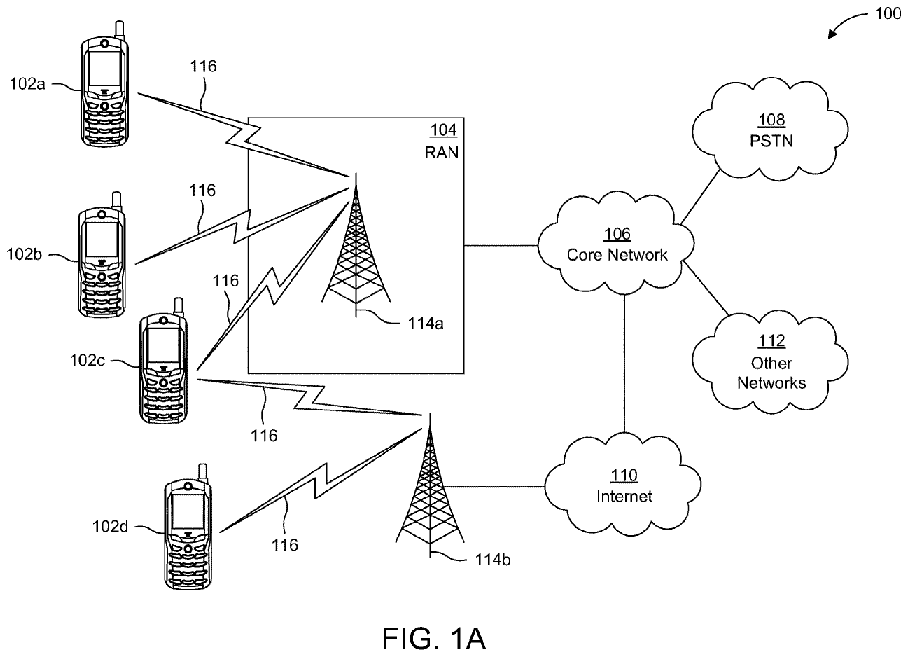

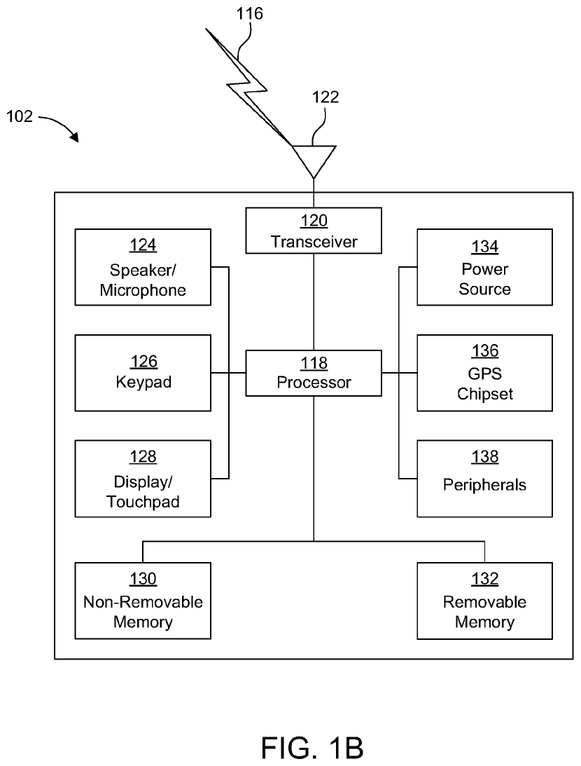

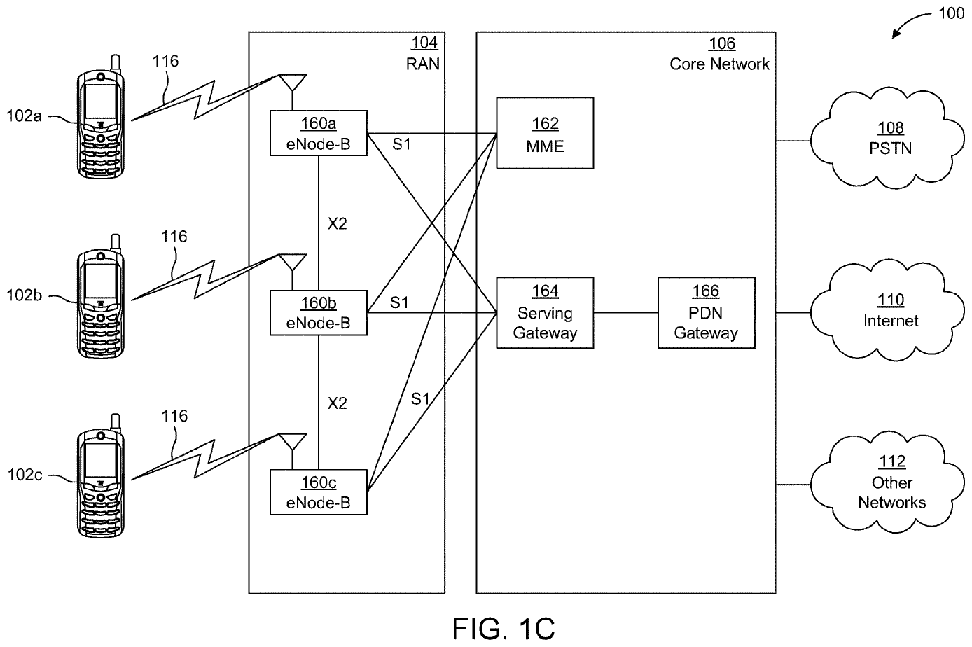

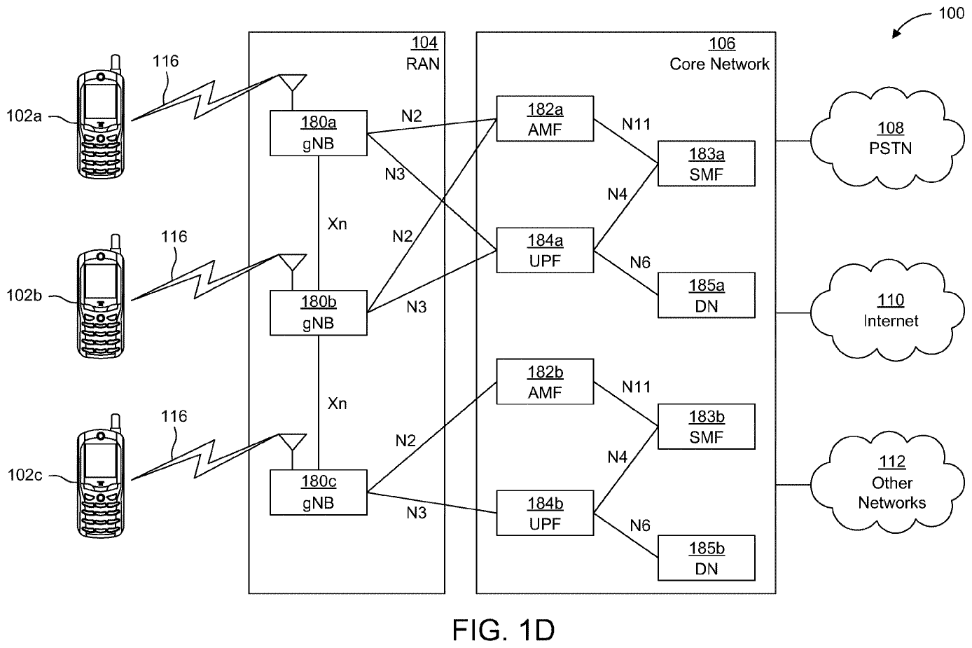

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In frequency range 2 (FR2), conventional beam management could result in beam sweeping and measurement over large number of antennas at the gNB side and the WTRU side. Upon selection of the best beams, the WTRU can report up to four beams, for example, based on reference signal received power (RSRP), in a beam management procedure.

Using artificial intelligence (AI)/machine learning (ML) models, FR2 beam selection/prediction can be performed based on frequency range 1 (FR1) channel state information (CSI) measurements. However, the realization of such a framework is subject to resolving the key challenges in beams' measurement and reporting as well as training and validation of the AI/ML model in scenarios with hierarchical spatial relations and associations between beam resources in different frequency ranges. Moreover, using of AI/ML model-based beam prediction may not be always beneficial. As an example instance, in case of non-line of sight (NLOS) communications, AI/ML based beam prediction may be inaccurate and traditional beam management procedure would be beneficial.

This results in different WTRU behavior in determining the associations, measuring, and reporting of the beam resources, as well as training, validation, activation and/or deactivation of the AI/ML models. Therefore, further investigation into hierarchical beam prediction in NR AI/ML beam management is required.

Embodiments and examples herein explain how to efficiently/dynamically activate/deactivate AI/ML model-based beam prediction. Accordingly, beam management procedures may be beneficially modified.

Methods regarding activation or deactivation of AI/ML models in beam prediction based on beam measurements on a different beam resource in an AI/ML framework are provided in embodiments and examples herein. In examples, the different beam resource may include resources with a different beamwidth, different frequency range, and so forth. Determining the accuracy of AI/ML models considering different use-cases and conditions are proposed herein, where different options to choose in activation or deactivation of the AI/ML model are provided. The iterative re-training/updating of AI/ML models based on AI/ML output and predicted beams is considered, where, in particular, conditions on AI/ML model retraining due to changes in the activation/deactivation set of transmission configuration indicator (TCI) states are provided herein. Finally, the AI/ML model validation for the beam prediction and based on reciprocity is presented herein.

Hereinafter, “a” and “an” and similar terms and phrases may be interpreted as “one or more” and “at least one.” Similarly, any term or phrase which ends with the suffix “(s)” is to be interpreted as “one or more” and “at least one.” The term “may” is to be interpreted as “may, for example.”

As used in embodiments and examples herein, AI may be broadly defined as the behavior exhibited by machines. Such behavior may, for example, mimic cognitive functions to sense, reason, adapt and act.

As used in embodiments and examples herein, ML may refer to types of algorithms that solve a problem based on learning through experience (“data”), without explicitly being programmed (“configuring set of rules”). ML can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning, with no labeled training data, and supervised learning, with only labeled training data.

As used in embodiments and examples herein, deep learning (DL) may refer to classes of machine learning algorithms that employ artificial neural networks, such as deep neural networks (DNNs), which were loosely inspired from biological systems. The DNNs are a special class of machine learning models inspired by a human brain wherein the input is linearly transformed and passed-through a non-linear activation function multiple times. DNNs typically consists of multiple layers where each layer consists of linear transformation and a given non-linear activation functions. The DNNs can be trained using the training data via a back-propagation algorithm. Recently, DNNs have shown state-of-the-art performance in variety of domains, for example, speech, vision, natural language, and the like and for various machine learning settings supervised, un-supervised, and semi-supervised. The term AI/ML (AIML) based methods/processing may refer to realization of behaviors and/or conformance to requirements by learning based on data, without explicit configuration of sequence of steps of actions. Such methods may enable learning complex behaviors which might be difficult to specify, difficult to implement, or both when using legacy methods.

A WTRU may transmit or receive a physical channel or reference signal (RS) according to at least one spatial domain filter. The term “beam” may be used to refer to a spatial domain filter, as used in embodiments and examples herein.

The WTRU may transmit a physical channel or signal using the same spatial domain filter as the spatial domain filter used for receiving an RS, such as a channel state information-reference signal (CSI-RS), or a synchronization signal (SS) block. The WTRU transmission may be referred to as a “target,” and the received RS or SS block may be referred to as “reference” or “source.” In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) signaling or signaled by a MAC control element (CE) or downlink control information (DCI). For example, a WTRU may implicitly transmit a physical uplink shared channel (PUSCH) transmission and a demodulation reference signal (DM-RS) of a PUSCH according to the same spatial domain filter as a sounding reference signal (SRS) indicated by an SRS resource indicator (SRI) indicated in DCI or configured by RRC signaling. In another example, a spatial relation may be configured by RRC signaling for an SRI or signaled by a MAC CE for a physical uplink control channel (PUCCH). Such a spatial relation may also be referred to as a “beam indication.”

The WTRU may receive a first (target) downlink channel or signal according to the same spatial domain filter or spatial reception parameter as a second (reference) downlink channel or signal. For example, such association may exist between a physical channel such as a physical downlink control channel (PDCCH) or a physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a TCI state. A WTRU may be indicated with an association between a CSI-RS or SS block and a DM-RS by an index to a set of TCI states configured by RRC signaling and/or signaled by a MAC CE. Such an indication may also be referred to as a “beam indication.”

As used herein, a transmission and reception point (TRP) may be interchangeably used with one or more of transmission point (TP), reception point (RP), radio remote head (RRH), distributed antenna (DA), base station (BS), a sector (of a BS), and a cell, but still be consistent with embodiments and examples provided herein. In an example, a cell may be a geographical cell area served by a BS. Further, as used herein, multi-TRP may be interchangeably used with one or more of MTRP, M-TRP, and multiple TRPs, but still consistent with embodiments and examples provided herein.

A WTRU may report a subset of CSI components, where CSI components may correspond to at least a CSI-RS resource indicator (CRI), a synchronization signal block (SSB) resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Indicator (LI), and/or the like.

Embodiments herein include activation/deactivation of beam prediction based on AI/ML modeling. Specifically, embodiments herein include AI/ML model activation/retraining/deactivation/fall back options. Further, embodiments herein include determining the accuracy of AI/ML models. Also, embodiments herein include use cases and conditions for which the AI/ML model can be used.

Embodiments herein include dynamic re-training/updating of AI/ML models. Specifically, embodiments herein include iterative re-training/updating of AI/ML models based on AI/ML. Further, embodiments herein include dynamic re-training/updating of AI/ML model based on changes in the activation/deactivation set of TCI states. Moreover, embodiments herein include AI/ML model beam prediction validation based on reciprocity.

Embodiments and examples herein include activation/deactivation of FR2 beam prediction based on AI/ML modeling. In examples provided herein, a WTRU is configured with one or more CSI-RS resources in FR1 for channel measurement. The WTRU derives one or more FR1 CSI parameters. One or more of the following may apply. The WTRU may determine one or more FR2 beam resources, may predict one or more FR2 beam resources, or may do both. The WTRU may make the determination, prediction, or both based on an AI/ML model, in an example. In an example, a beam resource may consist of a TCI state, CSI-RS or an SSB for downlink, an SRS resource, or a TCI state for uplink. Also, the WTRU may report one or more FR1 CSI parameters (e.g., multi-CRI) and the base station or gNB may perform FR2 beam prediction accordingly. The beam prediction may be made based on AI/ML model, in an example.

Further, the WTRU may receive one or more FR2 beam resources, which may be predicted FR2 resources. Also, the WTRU may receive one or more thresholds for the accuracy levels in the validation procedures. For example, the WTRU may receive thresholds for probability of LOS, CQI, block error rate (BLER), doppler shift, and so forth. Moreover, the WTRU may perform validation procedures based on one or more accuracy parameters, for example, on received FR2 beam resources.

Embodiments herein include AI/ML model activation/retraining/deactivation/fall back options. In an example, based on measured/determined accuracy parameters, the WTRU may determine to use one or more of following options. In case the accuracy parameters are acceptable, a first option may use/activate an AI/ML model in beam prediction.

In case the accuracy parameters are not acceptable, the WTRU may select from other candidate beam resources based on AI/ML prediction, in a second option. Further the WTRU may send a request for one or more FR2 candidate beam resources, for example, indicated by the base station or gNB, or determined by WTRU based on AI/ML models. The WTRU may initiate a corresponding timer/counter. Further, the WTRU may monitor/measure candidate beams. In case the accuracy measures are acceptable for a beam resource, then the WTRU may indicate a respective beam via a physical random-access channel (PRACH) or PUCCH. In case the counter/timer has exceeded respective maximum count/time, the WTRU may switch to a fourth option, explained further below.

A third option may update/retrain the parameter/model. The WTRU may send a request to update/retrain, for example, the AI/ML parameters/model. The WTRU may initiate a corresponding timer/counter. The WTRU may use the updated/retrained parameters/model for beam prediction in FR2. In case the accuracy measures are acceptable for a predicted FR2 beam resource, then WTRU may indicate respective beam(s) via PRACH or PUCCH. In case the counter/timer has exceeded respective maximum count(s)/time(s), the WTRU may switch to the fourth option, explained in the following.

The fourth option may include fall back. The WTRU may send a request to deactivate the AI/ML model and/or fall back to a conventional beam management mechanism.

Embodiments herein include determining the accuracy of AI/ML models. The WTRU may determine the accuracy parameters for the predicted FR2 beams based on validation procedures and respective thresholds. For example, for a predicted beam resource in FR2, if measured CSI parameters and/or hypothetical (Hyp.) PDCCH BLER are higher and/or lower than a corresponding threshold, respectively, the WTRU may determine that the accuracy parameters, for example, for an AI/ML model) are acceptable. In examples, the measured CSI parameters may include one or more of RSRP, signal-to-interference-and-noise ratio (SINR), CQI, and the like.

Further, embodiments and examples herein include that the WTRU may determine the accuracy based on association of one or more parameters. In examples, the one or more parameters may include one or more of CQI, Hypothetical, PDCCH BLER, RSRP, SINR, probability of LOS, Doppler shift, Doppler spread, average delay, delay spread, and so forth. For example, for a predicted beam resource in FR2, the probability of LOS is higher than a first threshold (e.g., LOS_th); however, the derived CQI is lower than respective threshold (e.g., CQI_th). As such, the WTRU may determine to perform the third option. In another example, for a predicted beam resource in FR2, the probability of LOS is lower than a first threshold (e.g., LOS_th) and the derived CQI is lower than a respective threshold (e.g., CQI_th). As such, the WTRU may determine to perform the second option or the fourth Option, for example, based on determined probability of LOS.

Additionally or alternatively, a WTRU may be configured with one or more of use-cases, for example, one or more subsets of cases, and/or conditions for which the AI/ML model can be used, for example, LOS, Antenna panel configurations, and the like. The WTRU may determine and send a request to a base station or gNB to fall back to FR2 beam management and deactivation of the AI/ML beam prediction, for example, based on the configured use cases.

Accordingly, one or more of the following may apply. An indication of LOS, a probability of LOS, or both may apply. Specifically, in case the probability of LOS is lower than a respective threshold for any of the CSI-RS resources, a WTRU may request to fall back. For example, the base station or gNB may configure multiple FR1 beams to find the one with the best probability of LOS to be used in AI/ML FR2 beam prediction.

Also, antenna panel configurations may apply. In an example, in case there is not the same QCL type D assumptions between FR1 and FR2 antenna ports and/or panels at WTRU side, the WTRU may determine to send a request to the base station to fall back to FR2 beam management and deactivation of the AI/ML beam prediction.

Moreover, the WTRU may use other conditions for activation/deactivation of AI/ML. For example, the other conditions may include a supported number of FR1 and FR2 beams. Further, the other conditions may include boresight of an antenna array, beam direction(s) of antennas, or antenna array configuration(s) for FR1 and FR2 at the WTRU side, at the base station or gNB side, or at both sides. Moreover, the other conditions may include WTRU capabilities.

Embodiments and examples herein include iterative training/updating AI/ML model based on AI/ML output predicted beam. A WTRU receives one or more sets of FR1 and FR2 beam resources and derives beam resource parameters, in an example. A beam resource may consist of one or more of a TCI state, a CSI-RS or an SSB for downlink, an SRS resource for uplink, or a TCI state for uplink.

In initial training, the WTRU may use the measured CSI parameters and TCI-states in beam prediction AI/ML model training. The measured CSI parameters may include one or more of CQI, PMI, CRI, or the like, in an example. The WTRU may determine one or more best FR2 beams, for example, based on RSRP. The WTRU may then report the predicted FR2 beams to the base station or gNB. The WTRU may receive one or more of the FR2 beams, for example, based on the reported FR2 beams. The WTRU may determine if the accuracy of the AI/ML and prediction are acceptable.

Re-training may optionally be used. If the accuracy is not in the acceptable range, the WTRU may use the received FR2 beams for re-training and/or updating respective AI/ML model parameters. For example, the WTRU may determine the number of additional information, for example, the number of FR2 beams for retraining.

The WTRU may use the measured CSI parameters in retrained/updated beam prediction AI/ML model and determines one or more best FR2 beams, for example, based on RSRP, accordingly. The measured CSI parameters may include one or more of CQI, PMI, CIR, or the like, in an example. The WTRU may determine if the re-training and updating of the model has resulted in different output, for example, different predicted FR2 beams, than the previous model.

If retraining of the model has resulted in new/different output, for example, different predicted FR2 beams, the WTRU may report the predicted FR2 beams to the base station or gNB. Otherwise, the WTRU may perform the re-training steps one or more times, for example, based on a timer or counter, and if unsuccessful, the WTRU determines to follow one or more of the activation/deactivation/fall back options.

Embodiments and examples herein include AI/ML model retraining due to changes in the activation/deactivation set of TCI states. A WTRU receives a set of activated/deactivated TCI states. The WTRU may receive the set in a MAC-CE, in an example. If the WTRU further receives a second, for example, updated/changed, set of activated/deactivated TCI states, for example, in a MAC-CE, one or more of the following may apply. The WTRU may determine if retraining of the AI/ML model is required. The WTRU may determine if the second set of the activated/deactivated TCI states are partially overlapped with the first set. If the overlap is more than a threshold, the WTRU may determine that retraining is not required. Otherwise, if the overlap is less than a threshold, the WTRU may determine that retraining of the AI/ML is required.

Embodiments herein include beam prediction AI/ML model validation based on reciprocity. In example, a WTRU determines/predicts one or more FR2 beams based on FR1 beam/CSI measurements. The WTRU performs a transmission to a base station or gNB based on the FR2 beam that WTRU has predicted. In an example, the transmission may include one or more of an SRS, hybrid automatic repeat request (HARQ) acknowledgement (Ack) or CSI-RS report. The base station or gNB may measure the channel, for example, the RSRP, based on the received FR2 signal. The base station or gNB may then change or validate the WTRU-side beam selection. WTRU may receive one or more FR2 CSI-RS measurement and reporting configurations that may be based on the selected beam at the base station or gNB. The measurement and reporting configurations may include one or more of CSI-RS resources, QCL information, TCI-state, or the like, in an example. The WTRU may measure the FR2 CSI and use the measured parameters to update/retrain the AI/ML model. WTRU may select and report the best beam and respective CSI quantities, for example, CSI-RSRP, CIR, or the like.

A WTRU may use channel and/or interference measurements. For example, a WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

Further, a WTRU may measure and report the CSI, wherein the CSI for each connection mode may include or be configured with one or more of following: a CSI Report Configuration, a CSI-RS Resource Set, or non-zero-power (NZP) CSI-RS Resources. A CSI Report Configuration may include one or more of the following: a CSI report quantity, for example, CQI, RI, PMI, CRI, LI, or the like; a CSI report type, for example, aperiodic, semi persistent, or periodic; a CSI report codebook configuration, for example, Type I, Type II, Type II port selection, and the like; or CSI report frequency. A CSI-RS Resource Set may include one or more of the following CSI Resource settings: an NZP-CSI-RS Resource for channel measurement; an NZP-CSI-RS Resource for interference measurement; or a CSI-IM Resource for interference measurement. NZP CSI-RS Resources may include one or more of the following: an NZP CSI-RS Resource identity (ID); Periodicity and offset; QCL Info and TCI-state; or Resource mapping, for example, a number of ports, density, code division multiplexing (CDM) type, and the like.

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

SS reference signal received power (SS-RSRP) may be measured based on the synchronization signals, for example, a demodulation reference signal (DMRS) in PBCH or SSS. SS-RSRP may be defined as the linear average over the power contribution of the resource elements (REs) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the REs that carry the respective CSI-RS. The CSI-RSRP measurement may be configured within measurement resources for the configured CSI-RS occasions.

SS-SINR may be measured based on the synchronization signals, for example, DMRS in PBCH or SSS. SS-SINR may be defined as the linear average over the power contribution of the REs that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the REs that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources, for example, co-channel serving and non-serving cells, adjacent channel interference, thermal noise, and so forth.

Cross-Layer interference received signal strength indicator (CLI-RSSI) may be measured based on the average of the total power contribution in configured OFDM symbols of the configured time and frequency resources. The power contribution may be received from different resources, for example, cross-layer interference, co-channel serving and non-serving cells, adjacent channel interference, thermal noise, and so forth.

Sounding reference signals RSRP (SRS-RSRP) may be measured based on the linear average over the power contribution of the REs that carry the respective SRS.

A CSI report configuration, for example, CSI-ReportConfigs, a beam/CSI report configuration, and the like, may be associated with a single bandwidth part (BWP), for example, indicated by BWP-Id, wherein one or more of the following parameters are configured: CSI-RS resources and/or CSI-RS resource sets for channel and interference measurement; CSI-RS report configuration type including the periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; Time restrictions for channel and interference measurements; Report frequency band configuration (wideband/subband CQI, PMI, and so forth); Thresholds and modes of calculations for the reporting quantities (CQI, RSRP, SINR, LI, RI, etc.); Codebook configuration; Group based beam reporting; CQI table; Subband size; Non-PMI port indication; Port Index; and so forth.

Examples provided herein may include a CSI-RS resource configuration. A CSI-RS Resource Set, for example, an NZP-CSI-RS-ResourceSet, may include one or more of CSI-RS resources, for example, an NZP-CSI-RS-Resource and CSI-ResourceConfig, wherein a WTRU may be configured with one or more of the following in a CSI-RS Resource: CSI-RS periodicity and slot offset for periodic and semi-persistent CSI-RS Resources; CSI-RS resource mapping to define the number of CSI-RS ports, density, CDM-type, OFDM symbol, and subcarrier occupancy; the bandwidth part to which the configured CSI-RS is allocated; or the reference to the TCI-State including the QCL source RS(s) and the corresponding QCL type(s).

Examples provided herein may include an RS resource set configuration. One or more of following configurations may be used for RS resource set. Specifically, a WTRU may be configured with one or more RS resource sets. Further, the RS resource set configuration may include one or more of following: an RS resource set ID; one or more RS resources for the RS resource set; repetition (i.e., on or off); aperiodic triggering offset (e.g., one of 0-6 slots); or tracking reference signal (TRS) info (e.g., true or not).

Examples provided herein may include an RS resource configuration. One or more of following configurations may be used for RS resource. For example, a WTRU may be configured with one or more RS resources. Further, the RS resource configuration may include one or more of following: an RS resource ID; resource mapping, for example, REs in a physical resource block (PRB); a power control offset (e.g., one value of −8, . . . , 15); power control offset with SS (e.g., −3 dB, 0 dB, 3 dB, 6 Db); a Scrambling ID; periodicity and offset; or QCL information, for example, based on a TCI state.

In the following, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); or any parameter provided in a DCI, by MAC or by RRC for the scheduling the grant or assignment.

In the following, an indication by DCI may consist of at least one of the following: an explicit indication by a DCI field or by RNTI used to mask cyclic redundancy check (CRC) of the PDCCH; or an implicit indication by a property such as DCI format, DCI size, Coreset or search space, Aggregation Level, first resource element of the received DCI, for example, an index of first Control Channel Element, where the mapping between the property and the value may be signaled by RRC or MAC.

Examples provided herein may include beam quality monitoring, radio link monitoring, or both. For example, a WTRU may use/receive/or be configured with one or more sets of reference signals per BWP for monitoring and detecting the beam failure detection. For example, the term q0 may be used for the beam failure detection set. In another example, the terms q0,0 or q0, 1 may be used as the beam failure detection sets. The beam failure detections sets, for example, set q0, q0,0, or q0,1, may include one or more reference signals, wherein the reference signals may be CSI-RS resource configuration indexes and/or SSB indexes. The reference signals included in beam failure detection RS sets may be the same the reference signals configured/used/received for RLM.

If a WTRU is not provided/configured with beam failure detection RS sets for a BWP, for example, set q0, q0,0, or q0,1, the WTRU may determine the respective RS sets. For example, the WTRU may determine the RS signals to be included in a beam failure detection RS set for a BWP based on the periodic CSI-RS resource configuration indexes that the WTRU uses for monitoring PDCCH in the respective CORESETs as indicated by TCI-state.

The WTRU may measure the reference signals included in beam failure detection RS sets and estimate radio link quality accordingly. The WTRU may use one or more thresholds/ranges for monitoring and estimating the radio link quality. For example, an out-of-sync threshold, for example, Q_out, an in-sync threshold, for example, Q_in, or both thresholds, may be used, wherein the thresholds Q_out, Q_in, or both may be used for estimating the quality of the radio link and/or respective beam. The terms Q_out and Q_in may be used to represent one or more attributes or parameters, and the respective values of the attributes or parameters.

The threshold Q_out may be used to determine the radio link and/or beam quality for which the signal transmission may not be reliably received, corresponding to out-of-sync block error rate (BLER_out). Additionally or alternatively, threshold Q_in may be used to determine the radio link and/or beam quality for which the signal transmission may be received reliably, corresponding to an in-sync block error rate (BLER_in). The BLER_out, BLER_in, or both may be explicitly determined by the base station or gNB.

In case BLER_out and/or BLER_in are not explicitly determined by the base station or gNB, they may be estimated based on one or more parameters. For example, the WTRU may use, receive, or be configured with PDCCH transmission parameters for performing the out-of-sync evaluation, in-sync evaluation, or both evaluations. In an example, the number of control OFDM symbols, aggregation level, ratio of hypothetical PDCCH RE energy to average SSS RE energy, ratio of hypothetical PDCCH DMRS energy to average SSS RE energy, BWP in number of PRBs, subcarrier spacing, and so forth may be used for determining the BLER_out threshold, BLER_in threshold, or both thresholds.

An example of PDCCH transmission parameters that may be included in evaluating the Q_out and Q_in thresholds is shown in Table 1 and Table 2, respectively. The tables are a non-limiting example of the parameters that may be included in evaluating the out-of-sync and in-sync thresholds. One or more of those parameters may be included. The values, number of PRBs, and choices for each parameter are examples. Other values, number of PRBs, or choices may be included.

TABLE 1
PDCCH transmission parameters for out-of-sync evaluation

| Attribute | Value for BLER Configuration #0 |
|---|---|
| DCI format | 1-0 |
| Number of control OFDM | 2 |
| symbols | |
| Aggregation level (CCE) | 8 |
| Ratio of hypothetical PDCCH | 4 dB |
| RE energy to average SSS | |
| RE energy | |
| Ratio of hypothetical PDCCH | 4 dB |
| DMRS energy to average | |
| SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

TABLE 2
PDCCH transmission parameters for in-sync evaluation

| Attribute | Value for BLER Configuration #0 |
|---|---|
| DCI payload size | 1-0 |
| Number of control OFDM | 2 |
| symbols | |
| Aggregation level (CCE) | 4 |
| Ratio of hypothetical PDCCH | 0 dB |
| RE energy to average SSS | |
| RE energy | |
| Ratio of hypothetical PDCCH | 0 dB |
| DMRS energy to average | |
| SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

Hereafter, the term RS may be interchangeably used with one or more of RS resource, RS resource set, RS port and RS port group, but still be consistent with embodiments and examples provided herein. Further, the term RS may be interchangeably used with one or more of SSB, CSI-RS, SRS, DM-RS, TRS, PRS, and phase tracking reference signal (PTRS), but still be consistent with embodiments and examples provided herein.

Hereafter, the phrase reference signal may be interchangeably used with one or more of the following, but still be consistent with embodiments and examples provided herein: SRS, CSI-RS, DM-RS, PT-RS, and/or SSB.

Hereafter, the term channel may be interchangeably used with one or more of following, but still be consistent with embodiments and examples provided herein: PDCCH, PDSCH, PUCCH, PUSCH, PRACH and the like. Hereafter, the phrase RS resource set may be interchangeably used with one or more of an RS resource and a beam group, but still be consistent with embodiments and examples provided herein.

Hereafter, the phrase beam reporting may be interchangeably used with one or more of CSI measurement, CSI reporting and beam measurement, but still be consistent with embodiments and examples provided herein. Hereafter, the proposed solutions for beam resources prediction may be used for beam resources belonging to a single or multiple cells as well as single or multiple TRPs, and still be consistent with embodiments and examples provided herein.

Hereafter, the phrase CSI reporting may be interchangeably used with one or more of CSI measurement, beam reporting and beam measurement, but still be consistent with embodiments and examples provided herein. Hereafter, the term quality or the phrase measure quality may be interchangeably used with one or more of RSRP, reference signal received quality (RSRQ), SINR, CQI, modulation and coding scheme (MCS), hypothetical PDCCH BLER, PDSCH BLER, LOS probability and the like, but still be consistent with embodiments and examples provided herein.

Embodiments and examples of activation/deactivation of beam prediction based on AI/ML modeling are provided herein. In an example, a WTRU may receive one or more CSI report configurations. For example, a WTRU may receive a CSI-ReportConfig. In an example, the WTRU may receive the one or more CSI report configurations from a base station. A CSI report configuration may include a CSI report quantity that may indicate the CSI parameters that may be required to be measured/estimated/derived and reported. In an example, the CSI report quantity could be one or more of the CQI, RI, PMI, CRI, LI, SINR, RSRP, and so forth.

The CSI report configuration may be associated with one or more CSI resource settings, such as, for example, a CSI-ResourceConfig, for channel/interference measurement. A resource setting may include a list of CSI Resource Sets, where the list may comprise of references to one or more CSI-RS resource sets, SSB sets, or both types of sets.

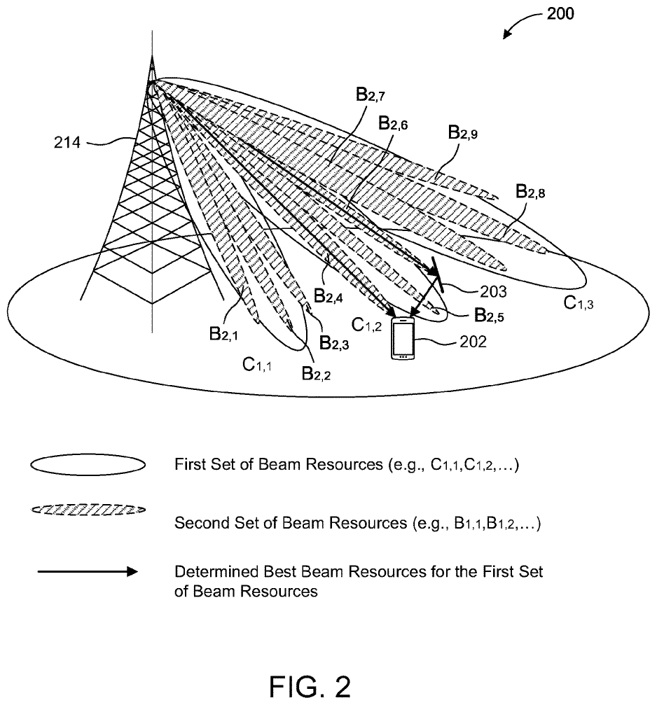

FIG. 2 is a system diagram illustrating an example of beam prediction in a second set of beam resources based on a beam resources reported in a first set of beam resources. An example shown in FIG. 2 presents a WTRU that is configured with a first set of beam resources. The first set of beam resources may be CSI-RS resources, TCI states, and the like, for example. In addition, the first set of beam resources may be in a first frequency range, for example, FR1, and/or a first beamwidth, for example, a wide beamwidth for a wide beam, that are shown as C_{1,1}, C_{1,2}, and C_{1,3} as an example.

Also, the WTRU is configured with a second set of beam resources. The second set of beam resources may be CSI-RS resources, TCI states, and the like, for example. Further, the second set of beam resources may be in a second frequency range, for example, FR2 and/or a second beamwidth, for example, a narrow beamwidth for a narrow beam, that are shown as B_{2,1}, B_{2,2}, . . . , B_{2,9} as an example in FIG. 2.

The WTRU may perform measurements on one or more CSI-RS resources and derive one or more CSI parameters. In an example, the WTRU may determine that the best beam resource in the first set of beam resources may be C_{1,2} in FIG. 2. For example, the WTRU may determine that beam C_{1,2} is the best beam because it is the beam with highest the RSRP or LOS. For example, the WTRU may determine the best PMI(s) in the first set of CSI-RS resources that are shown with the directional arrows, pointing from base station 214 to WTRU 202 and blockage 203. In an example shown in system diagram 200, blockage 203 reflects a signal received from base station 214 to WTRU 202.

The WTRU may report the determined parameters, such as CSI parameters, in the first set of CSI-RS resources, such as, for example, RSRP, RI, LI, SINR, PMI, CQI, and the like, for respective selected beam resource, such as, for example, C_{1,2}. At the base station 214, which may be a gNB in an example, the reported CSI parameters may be used to predict, for example, based on an AI/ML model, one or more of the best beam resources in the second frequency range, for example, FR2.

Additionally or alternatively, the WTRU may determine one or more best beam resources in the second set, for example, based on the AI/ML model. For example, the beams B_{2,4} and B_{2,6} in FIG. 2 may be selected/determined/predicted, for example, based on best PMI. As such, the WTRU may report the determined/selected beam resources, for example, beam index or CRIs, and respective predicted RSRP/SINR for up to a maximum number of beams, for example, up to four beams. In an example, the respective predicted RSRP/SINR may include L1-RSRP, L1-SINR, and the like. In other words, the best beam resources in the second frequency range may be determined, based on the AI/ML model, without excessive beam sweeping either at the base station 214, which may be a gNB, or at the WTRU 202.

In a framework based on beam prediction for a second frequency range and based on measurements in a first frequency range, for example, based on AI/ML models, the beam prediction may not be as accurate, and further verification and validation may be required. One of ordinary skill in the art will appreciate that one or more problems are addressed by embodiments and examples provided herein. For example, how is the beam prediction, for example, based on AI/ML) validated? How can one differentiate if the low quality of the prediction, for example, a predicted beam with low RSRP, is due to the AI/ML model's poor behavior or it has other causes? How to address the cases with low quality of prediction, for example, a predicted beam with low RSRP/CQI?

In an example, the WTRU may activate an AI/ML model in beam prediction based on one or more accuracy parameters for candidate beam resources. The WTRU may select other candidate beam resources based on an AI/ML beam prediction. Further, the WTRU may determine accuracy parameters for beams predicted by the AI/ML model. Moreover, the WTRU may deactivate the AI/ML beam prediction based on one or more of an indication of line of sight (LOS), a probability of LOS, an antenna panel configuration, a supported number of beams, an antenna array, or WTRU capabilities. Also, the WTRU may use measured CSI parameters and TCI states in beam prediction for initial training of the AI/ML model.

In an example solution, a WTRU may determine or be configured to perform validation on the AI/ML output. As an example, the AI/ML model may be used for prediction of beam resources in a second frequency range, based on measurements, such as CSI measurements, in a first frequency range. For example, the AI/ML model may be performed at WTRU and/or at gNB. A beam resource may consist of a TCI state, CSI-RS or a SSB for downlink, an SRS resource or TCI state for uplink.

The WTRU may determine, indicate, or be configured to receive and measure one or more of CSI/beam resource parameters in order to verify the validity and/or accuracy of the AI/ML output. In an example, the WTRU may suggest, report, or request the base station or gNB to transmit one or more channels/signals corresponding to the predicted beam resources, for example, same QCL, same spatial relation, or same of both. The one or more channels/signals may be a PDCCH, a CSI-RS signal, or the like, in an example. In another example, the WTRU may be configured to receive and measure one or more channels/signals, for example, PDCCH, CSI-RS signals, and so forth, corresponding to the predicted beam resources, for example, same QCL, same spatial relation, or same of both. As an instance, the requested/configured beam resources may be in the second frequency range, for example, in FR2.

The WTRU may determine or be configured to derive measurements on one or more parameters of the configured/determined beam resources. As an example, the WTRU may be configured to derive CSI parameters based on configured/received CSI-RS signals, for example, probability of LOS, PMI, CQI, RSRP, SINR, doppler shift, and so forth. In another example, the WTRU may be configured to derive parameters corresponding to received channels, for example, PDCCH hypothetical BLER. Moreover, the WTRU may determine or be configured with one or more thresholds associated with the parameters that are determined/configured to be measured. Also, the WTRU may determine or be configured with one or more limit/maximum/minimum values associated with timers/counters that are used in validation procedures.

The WTRU may determine/report the validity of the AI/ML model, whereas the WTRU may determine/report the AI/ML to be “valid” (measured accuracy is acceptable) or “not valid” (measured accuracy is not acceptable). As such, in case the measured parameters or the association/combination of the measured parameters are in an acceptable range, the WTRU may determine the AI/ML model to be “valid” and to have “acceptable accuracy”. In a contrary case, in case the measured parameters or the association/combination of the measured parameters are not in acceptable ranges, the WTRU may determine that the AI/ML model is “not valid” and that the model “does not have acceptable accuracy.”

In an example solution, the WTRU may be configured with one or more options to select from in case of different conditions based on the measurements, thresholds, and validation scenarios. One or more of the following example may apply, accordingly.

Under Option 1, the WTRU may use an AI/ML model in beam prediction, activate AI/ML model in beam prediction, or do both. For example, the WTRU may determine that the respective AI/ML model is valid, and its accuracy is acceptable. As such, the WTRU may determine to use/activate the respective AI/ML model, for example, for beam prediction.

Under Option 2, the WTRU may select from other candidate beam resources based on AI/ML prediction. For example, the WTRU may determine or be configured with one or more candidate (predicted) beams, for example, based on AI/ML model. As such, in case the WTRU detects/determines that the best (predicted) beam is not showing acceptable accuracy, the WTRU may determine to monitor one or more of the candidate (predicted) beams. In examples, not showing acceptable accuracy may be shown by CQI less than a threshold, RSRP less than a threshold, or both, or by PDCCH Hypothetical BLER higher than a threshold.

Under Option 3, the parameters, the model, or both may be updated, retrained, or both. For example, the WTRU may determine that the reason that the predicted beam, for example, based on AI/ML, does not have an acceptable accuracy is due to the AI/ML model. As such, the WTRU may determine, suggest, or send a request to update the AI/ML model, to retrain the AI/ML model, or to do both.

Under Option 4, the WTRU may fallback to legacy procedure, deactivate the AI/ML model or both. For example, the WTRU may determine that the quality, the accuracy, or both of the (predicted) beam is below one or more thresholds, wherein the WTRU may determine the AI/ML model to be invalid. Therefore, the WTRU may determine to deactivate the AI/ML model, fall back to legacy, or do both. In an example, fall back to legacy may include using non-AI/ML model based procedures.

In an example solution, the WTRU may determine to change the selected option based on measured accuracy parameters, one or more timer/counter, and so forth. In an example, the WTRU may determine to operate in Option 2, where the WTRU may initiate a timer or counter, for example, for the number of monitored candidate beams. In case the timer (counter) expires (reaches to maximum) before the WTRU could find another candidate beam with acceptable accuracy, the WTRU may determine to select another option. For example, the WTRU may determine to select Option 3 or 4. Additionally or alternatively, if the WTRU determines that one or more of the candidate beams have acceptable accuracy, such as before the timer (counter) expires (reaches to maximum), the WTRU may report the determined beam and the WTRU may determine to select the option to use/activate AI/ML model, for example, as in Option 1.

In another example, the WTRU may determine to operate in Option 3, where the WTRU may initiate a timer, a counter, or both. In case the updating/retraining of the model results in the WTRU determining one or more beams with acceptable accuracy before the timer (counter) expires (reaches the maximum), the WTRU may determine to select the option on using, activating, or both, the (retrained/updated) AI/ML model, for example, as in Option 1. In the contrary case, if the timer expires (and/or counter reaches its maximum limit) and the WTRU determines that updating/retraining of the AI/ML model has not resulted in acceptable accuracy, then the WTRU may determine the option to fallback or deactivate the AI/MI model, for example, as in Option 4.

In an example solution, a WTRU may determine and/or establish accuracy parameters and validation procedures based on the association/combination of one or more CSI, beam, channel, environment and/or mobility parameters. For example, the WTRU may determine to establish the association based on one or more parameters as follows.

The WTRU may determine to establish the association based on beam resources parameters. For example, the WTRU may determine the parameters corresponding to the beam resources and CSI quantities such as RSRP, SINR, CQI, PMI, RI, LI, Hypothetical PDCCH BLER, and so forth along with respective thresholds.

The WTRU may determine to establish the association based on channel, mobility, and environment parameters. For example, the WTRU may determine the parameters corresponding to the channel, environment, and mobility such as probability of LOS, Doppler shift, Doppler spread, average delay, delay spread, and so forth along with respective thresholds.

As an example, the WTRU may determine the accuracy parameters based on association/combination of the CSI and/or beam parameters along with environment, mobility, and channel parameters for the (predicted) beam resources with respect to respective thresholds. For example, a WTRU may determine one or more accuracy levels based on association of CQI, combination of CQI, or both, and probability of LOS. For example, if the measured probability of LOS and the measured received power and/or channel quality, for example, CQI, RSRP, SINR, and so forth, are higher than respective thresholds, the WTRU may determine that the AI/ML model performance is acceptable and therefore the WTRU may determine to validate the AI/ML model and use/activate respective AI/ML model, for example, as in Option 1.

For example, the measured probability of LOS may be higher than respective threshold, whereas the measured received power and/or channel quality (e.g., CQI, RSRP, SINR, and so forth) is lower than respective threshold. In that case, the WTRU may determine that the accuracy of the AI/ML is not acceptable. Therefore, the WTRU may determine to update the AI/ML model, for example, as in Option 3. For example, if the measured probability of LOS and the measured received power and/or channel quality, for example, CQI, RSRP, SINR, and so forth, are lower than respective thresholds, the WTRU may determine to monitor/measure one or more candidate (predicted) beams, for example, as in Option 2.

In an example solution, a WTRU may suggest, request, or report the result of validation and the determined options, such as to activate/deactivate the AI/ML model, to the base station or gNB. In an example, the WTRU may suggest, request, or report the result and options as part of a CSI report, as a flag in HARQ-ACK, as a parameter in PUCCH, as a parameter in PRACH, via uplink control information (UCI) in PUSCH, and so forth.

In another example solution, a WTRU may determine or be configured with one or more use-cases (or subsets of use-cases), for which the WTRU determines to use, activate, or deactivate the AI/MI model. As an example, the WTRU may determine to activate the AI/ML model, deactivate the AI/ML model, or both, based on one or more of the following: an indication of LOS, a probability of LOS, or both; antenna panel configurations; other conditions; or all of these.

For example, using an indication of LOS, a probability of LOS, or both, the WTRU may deactivate the AI/ML model in case the probability of LOS is lower than a respective threshold for any of the configured/determined beam resources, such as in the first frequency range, for example, in FR1. For example, the WTRU may be configured to determine, to report, or both, the beam with the best probability of LOS, highest probability of LOS, or both, for example, between multiple beams in a first frequency range, for example, in FR1. As such, the determined/reported beam may be used, at a base station or gNB, and/or WTRU, for AI/ML beam prediction, for example, in a second frequency range, for example, in FR2.

In an example using antenna panel configurations, the WTRU may deactivate the AI/ML model in case there are not the same QCL type D assumptions between the antenna ports, panels, or both (at WTRU side) for the first and second frequency ranges, for example, for FR1 and FR2.

The WTRU may use other conditions for activation/deactivation of AI/ML, for example: a supported number of beams, beam properties, WTRU capabilities, or all of these. For example, using a supported number of beams, the WTRU may determine or be configured to use/activate the AI/ML model only for a range of beams in the first and second frequency ranges, for example, in FR1 and FR2.

For example, using beam properties, the WTRU may determine or be configured to activate the AI/ML model in case one or more determined or configured parameters are in an acceptable range, for example, boresight of antenna array, beam direction of antennas, or antenna array configuration, for the first and second frequency ranges, such as at the WTRU, at a gNB or base station, or at both the WTRU and gNB or base station. The WTRU may determine to deactivate the AI/ML model, otherwise.

For example, using WTRU capabilities, the WTRU may determine or be configured to activate the AI/ML model in case of having one or more WTRU capabilities, for example, processing time, antenna switching time, BWP switching time, and so forth. The WTRU may determine to deactivate the AI/ML model, otherwise.

Examples are provided herein of AI/ML model activation/retraining/deactivation/fall back options. One or more of following configurations may be used for CSI/beam reporting configuration. A WTRU may be configured with one or more CSI report configurations. Also, a WTRU may be configured with one or more beam report configurations. The CSI report configurations may include one or more of following: report configuration type, for example, periodic, semi-persistent on PUCCH, semi-persistent on PUSCH or aperiodic; report quantity, for example, CRI-RI-PMI-CQI, CRI-RI-i1, CRI-RI-i1-CQI, CRI-RSRP, SSB-Index-RSRP, CRI-RI-LI-PMI-CQI, CRI-SINR, SSB-Index-SINR; report frequency configuration; CQI format indicator, such as wideband CQI or subband CQI; PMI format indicator, such as wideband PMI or subband PMI; CSI reporting band; time restriction for channel measurements; time restriction for interference measurements; codebook configuration; group based beam reporting; CQI table; subband size; non-PMI port indication; report slot configuration/offset list; CSI report periodicity and offset; one or more PUCCH resources for CSI reporting; a Port Index; or a combination of any or all of these.

One or more of following configurations may be used for measurement configuration of CSI/beam reporting. A WTRU may be configured with one or more CSI measurement configurations. Also, a WTRU may be configured with one or more beam measurement configurations. The CSI measurement configurations may include one or more of following: RS for channel measurement; RS for interference measurement (zero power or non-zero power); report trigger size; aperiodic trigger state list; semi-persistent on PUSCH trigger state list; associated CSI resource configurations; associated CSI report configurations; or a combination of any of all of these. Similar parameters may be included in beam measurement configurations.

One or more of following configurations may be used for CSI resource configurations. A WTRU may be configured with one or more CSI resource configurations. The CSI resource configuration may include one or more of following: CSI resource config 1D; one or more RS resource sets for channel measurement; one or more RS resource sets for interference measurement; bandwidth part ID; or Resource type, for example, aperiodic, semi-persistent or periodic.

In an example solution, a WTRU may activate/apply an AI/ML model, deactivate an AI/ML model, update/retrain an AI/ML model or trigger a procedure for selecting one or more new beams. The activation of the AI/ML model may comprise one or more of the following: activation of one or more RS resources/resource sets associated with the AI/ML model; activation of one or more CSI report configurations associated with the AI/ML model; activation of one or more measurement configurations associated with the AI/ML model; activation of one or more CSI resource configurations associated with the AI/ML model; resetting/initiating one or more counters associated with the AI/ML model; or resetting/initiating one or more timers associated with the AI/ML model.

The deactivation of an AI/ML model may comprise one or more of the following: deactivation of one or more RS resources/resource sets associated with the AI/ML model; deactivation of one or more CSI reporting configurations associated with the AI/ML model; deactivation of one or more measurement configurations associated with the AI/ML model; deactivation of one or more CSI resource configurations associated with the AI/ML model; resetting one or more counters associated with the AI/ML model; or resetting one or more timers associated with the AI/ML model.

The procedure for updating/retraining an AI/ML model or associated parameters/weights may include one or more of the following: sending a request/indication to update AI/ML model or associated parameters/weights; Resetting/initiating one or more counters associated with the procedure; resetting/initiating one or more timers associated with the procedure; updating the AI/ML model and associated parameters/weights; applying/using the updated AI/ML model and associated parameters/weights; or selecting one or more RSs/beams based on the updated AI/ML model and associated parameters/weights. The WTRU may select the one or more RSs/beams based on quality. For example, a WTRU or a base station, or gNB, may select one or more RSs/beams with the best qualities.

The procedure for updating/retraining an AI/ML model or associated parameters/weights may further include one or more of the following measuring the one or more selected RSs/beams based on the updated AI/ML model and associated parameters/weights; indicating the one or more selected RSs/beams; or indicating deactivation of AI/ML model and/or fall back to conventional beam management mechanism if the procedure is not successful. In an example solution regarding indicating the one or more selected RSs/beams, a WTRU or a base station, or gNB, may indicate the one or more selected beams RSs/beams. For example, the WTRU and/or the base station, or gNB, may indicate the one or more selected RSs/beams if the measured quality of the one or more selected RSs/beams are greater than or equal to (>=) a threshold.

Example solutions include indicating deactivation of AI/ML model and/or fall back to conventional beam management mechanism if the procedure is not successful. For example, the WTRU may determine the procedure is not successful if the one or more of the following conditions are satisfied: timer (if a timer associated with the procedure expires, the WTRU may determine the procedure as not successful); counter (the WTRU may increase the counter when the WTRU measures candidate RSs and/or the measured qualities of the candidate RSs is smaller than one or more first thresholds; if the counter is larger than a second threshold, the WTRU may determine the procedure as not successful); or measured quality (if measured qualities of the one or more candidate beams<a threshold, the WTRU may determine the procedure as not successful).

The procedure for selecting one or more new beams may comprise one or more of the following: triggering/requesting one or more candidate beam resources; resetting/initiating one or more counters associated with the procedure; resetting/initiating one or more timers associated with the procedure; monitoring/measuring candidate beams/RSs; selecting one or more RSs/beams; indicating the one or more selected beams; or indicating deactivation of an AI/ML model and/or fall back to conventional beam management mechanism if the procedure is not successful. In an example regarding selecting one or more RSs/beam, the WTRU may select the one or more beams based on quality. For example, a WTRU or a base station, or gNB, may select one or more RSs/beams with the best qualities.

In an example regarding indicating the one or more selected beams, a WTRU may indicate one or more selected beams to a base station or gNB. Further, the WTRU may indicate the one or more beams by transmitting one or more UL resources. The one or more UL resources may be one or more of the following: PRACH (for example, the WTRU may transmit one or more PRACHs (e.g., in associated PRACH resources with the one or more selected beams); PUCCH (for example, the WTRU may indicate one or more RS indexes and/or beam indexes (e.g., as a part of CSI) by using one or more PUCCHs (e.g., in associated PUCCH resources with the procedure or the one or more selected beams)); or PUSCH (for example, the WTRU may indicate one or more RS indexes and/or beam indexes (e.g., as a part of CSI) by using one or more PUSCHs). Further, the WTRU may receive a confirmation from the base station or gNB. For example, the WTRU may receive one or more PDCCHs in one or more CORESETs/search spaces, for example, associated with the procedure.

In another example regarding indicating the one or more selected beams, a base station or gNB may indicate one or more selected beams to the WTRU, for example, via one or more of RRC, MAC CE and DCI. Further, the WTRU may receive the indication based on one or more of the following: TCI state; or beam index. In an example of receiving the TCI state, the WTRU may receive an indication of one or more TCI states associated with the selected beams. In an example of receiving the beam index, the WTRU may receive an indication of one or more beam indexes associated with the selected beams.

In an example regarding indicating deactivation of AI/ML model and/or fall back to conventional beam management mechanism if the procedure is not successful, the WTRU may determine the procedure is not successful if the one or more of the following conditions are satisfied: a timer, a counter, or a measured quality. For example, if a timer associated with the procedure expires, the WTRU may determine the procedure as not successful. In a counter example, the WTRU may increase the counter when the WTRU measures candidate RSs and/or the measured qualities of the candidate RSs is smaller than one or more first thresholds. If the counter is larger than a second threshold, the WTRU may determine the procedure as not successful. In a measured quality example, if measured qualities of the one or more candidate beams are less than (<) a threshold, the WTRU may determine the procedure as not successful.

The activation of an AI/ML model, deactivation of the AI/ML model, updating/retraining of AI/ML models and associated parameters/weights, and triggering new beam selection procedure may be based on one or more of the following: a base station or gNB indication, or a WTRU indication. In an example solution, the WTRU may receive an indication, for example, one or more of RRC signaling, a MAC CE or DCI, from a base station or gNB to activate/deactivate one or more AI/ML models, update one or more AI/ML models and associated parameters, or trigger new beam selection procedure. The indication may be based on one or more of the following: an explicit indication; or an indication based on one or more configurations associated with one or more AI/ML models.

In an example of an explicit indication, the WTRU may receive an indication of activation/deactivation or triggering updating procedure for one or more AI/ML models or triggering beam selection procedure. The explicit indication may comprise one or more of the following.

For example, the WTRU may receive an indication of procedure type. For example, the WTRU may receive one or more of activation, deactivation, updating or new beam selection.

The indication may comprise an indication triggering an updating AI/ML model procedure. For example, one bit may indicate triggering updating AI/ML model procedure. For example, if the bit is “1”, updating procedure may be triggered. If the bit is “0”, updating procedure may not be triggered.

The indication may comprise an indication of triggering a new beam selection procedure. For example, one bit may indicate triggering new beam selection procedure. For example, if the bit is “1”, new beam selection procedure may be triggered. If the bit is “0”, new beam selection procedure may not be triggered.

The indication may comprise an AI/ML model ID. For example, the WTRU may receive one or more AI/ML model IDs to be activated/deactivated/updated. The explicit indication may not comprise AI/ML model ID if the new beam selection is triggered.

The indication may comprise a bitmap of an AI/ML model. For example, each bit of the bitmap may be associated with each AI/ML model. For example, if a bit is “1”, AI/ML model associated with the bit may be activated. If the bit is “0”, AI/ML model associated with the bit may be deactivated. The explicit indication may not comprise the bitmap of AI/ML model if the new beam selection is triggered.

In example, the indication may be based on one or more configurations associated with one or more AI/ML models. For example, the WTRU may receive an indication of activation/deactivation/update for one or more configurations. For example, if the WTRU receives an indication of activation for a first set of configurations, the WTRU may activate a first set of AI/ML models associated with the first set of configurations. If the WTRU receives an indication of deactivation for a second set of configurations, the WTRU may deactivate a second set of AI/ML models associated with the second set of configurations. If the WTRU receives an indication of update for a third set of configurations, the WTRU may update a third set of AI/ML models associated with the third set of configurations. If the WTRU receives an indication of new beam selection for a fourth set of configurations, the WTRU may select one or more new beams for a third set of AI/ML models associated with the third set of configurations. The one more configurations may be one or more of the following: CSI report config; Measurement config; CSI resource config; RS resource config; and/or RS resource set config.

The following include examples of activation of an AI/ML model, deactivation of the AI/ML model, updating/retraining of AI/ML models and associated parameters/weights, and triggering new beam selection procedure based on a WTRU indication. In an example solution, the WTRU may indicate a preferred mode, for example, one or more of activate, deactivate, update and new beam selection to a base station or gNB. The indication may be based on one or more of the following: an explicit indication for all AI/ML models, an indication per AI/ML model, an indication per configuration, or a quality measurement.

The WTRU may explicitly indicate a preferred mode for all AI/ML models. For example, one bit of information may be used for indicating activation/deactivation. For example, 1 may indicate activation of all AI/ML models, or activation of AI/ML mode, and 0 may indicate deactivation of all AI/ML models, or deactivation of AI/ML mode. For example, one bit information may be used for indicating update. For example, 1 may indicate update of all AI/ML models and 0 may indicate no update of all AI/ML models. For example, one bit of information may be used for triggering a new beam selection procedure. For example, 1 may indicate selecting one or more new beams, new RSs, or both for all AI/ML models, and 0 may indicate no selection of one or more new beams/RSs.

The WTRU may indicate a preferred mode per AI/ML model or for each AI/ML model. For example, 1 may indicate activation of an AI/ML model associated with the indication and 0 may indicate deactivation of an AI/ML model associated with the indication. For example, 1 may indicate update of an AI/ML model associated with the indication and 0 may indicate no update of an AI/ML model associated with the indication. For example, 1 may indicate selecting one or more new beams, new RSs, or both for an AI/ML model associated with the indication and 0 may indicate no selection of one or more new beams, new RSs, or both for an AI/ML model associated with the indication.

The WTRU may indicate a preferred mode per configuration or for each configuration. For example, 1 may indicate activation of an AI/ML model associated with the config and 0 may indicate deactivation of an AI/ML model associated with the configuration. For example, 1 may indicate update of an AI/ML model associated with the config and 0 may indicate no update of an AI/ML model associated with the configuration. For example, 1 may indicate selecting one or more new beams, new RSs, or both for an AI/ML model associated with the indication and 0 may indicate no selection of one or more new beams, new RSs, or both for an AI/ML model associated with the configuration. The configuration may be one or more of the following: CSI report config; Measurement config; CSI resource config; RS resource config; or RS resource set config.

In an example solution, the WTRU may activate/deactivate/update one or more AI/ML models or trigger new beam selection procedure based on one or more measured qualities. In an example solution, the procedure may be based on a threshold and a quality measurement, for example, reported quality to a base station or gNB, for each procedure. For example, if measured quality is greater than or equal to (>=) a threshold, the WTRU may indicate, may determine, or both, activation of the AI/ML model. If the measured quality is less than (<) a threshold, the WTRU may indicate, may determine, or both, deactivation of the AI/ML model.

For example, if measured quality is greater than or equal to (>=) a threshold, the WTRU may indicate, may determine, or both, no update of the AI/ML model. If the measured quality is less than (<) a threshold, the WTRU may indicate, may determine, or both, an update of the AI/ML model. In another example, if measured quality is greater than or equal to (>=) a threshold, the WTRU may indicate/determine no new beam selection for the AI/ML model. If the measured quality is less than (<) a threshold, the WTRU may indicate/determine new beam selection of the AI/ML model.

In an example solution, the procedure may be based on two or more thresholds and a quality measurement. For example, if measured quality is greater than or equal to (>=) a first threshold, the WTRU may indicate, may determine, or both, activation of an AI/ML model. If a second threshold is less than (<) the measure quality, which may be less than (<) the first threshold, the WTRU may trigger/indicate/determine the new beam selection procedure. If the measured quality is less than (<) the second threshold, the WTRU may indicate, may determine, or both deactivation of the AI/ML model.

For example, if measured quality is greater than or equal to (>=) a first threshold, the WTRU may indicate, may determine, or both activation of the AI/ML model. If a second threshold is less than (<) the measure quality, which may be less than (<) the first threshold, the WTRU may trigger/indicate/determine the AI/ML update procedure. If the measured quality is less than (<) the second threshold, the WTRU may indicate, may determine, or both deactivation of the AI/ML model.

In an example solution, the procedure may be based on two or more quality measurements and two or more thresholds. For example, if a first measured quality, for example, RSRP, RSRQ, SINR, MCS or CQI, is greater than or equal to (>=) a first threshold and a second measure quality, for example, LOS probability, is greater than or equal to (>=) a second threshold, the WTRU may indicate, may determine, or may do both, activation of AI/ML model. If the first measured quality, for example, RSRP, RSRQ, SINR, MCS or CQI, is less than (<) the first threshold and the second measure quality, for example, LOS probability, is greater than or equal to (>=) the second threshold, the WTRU may indicate, may determine, or may do both, an update of AI/ML model. If the first measured quality, for example, RSRP, RSRQ, SINR, MCS or CQI, is less than (<) the first threshold and the second measure quality, for example, LOS probability, is less than (<) the second threshold, the WTRU may indicate, may determine, or may do both, deactivation of AI/ML model, triggering new beam selection procedure, or both.

If the WTRU reports two or more measured qualities, the WTRU may indicate activation/deactivation/triggering new beam selection procedure based on one or more of the following: an indication per measure quality, an indication of all measure qualities, or both. The WTRU may indicate activation/deactivation/triggering new beam selection procedure per measured quality. The WTRU may indicate activation/deactivation/triggering new beam selection procedure for all measured qualities. The WTRU may determine activation/deactivation/triggering new beam selection procedure based on the one or more of the following. For example, the WTRU may determine activation/deactivation/triggering new beam selection procedure based on an average. Further, The WTRU may determine activation/deactivation/triggering new beam selection procedure in an example where the WTRU may average the all measured qualities, and the WTRU may indicate activation if the average quality is greater than (>=) the threshold. Also, the WTRU may determine activation/deactivation/triggering new beam selection procedure based on a number of measured qualities which is greater than (>=) the threshold. Moreover, the WTRU may determine activation/deactivation/triggering new beam selection procedure where the WTRU may indicate activation if the number of measure qualities is greater than or equal to (>=) the threshold.

In an example solution, the WTRU may receive a confirmation of the WTRU indication/determination. For example, the WTRU may receive a PDCCH in one or more CORESETs/search spaces associated the WTRU indication. In another example, the WTRU may receive a confirmation message via one or more of RRC signaling, a MAC CE or DCI.

Examples are provided herein of methods to determine or obtain the accuracy of an AI/ML model. The phrases accuracy of an AI/ML model and validity of an AI/ML model may be used interchangeably and still be consistent with examples provided herein. The phrases frequency region or frequency range may be used interchangeably and still be consistent with examples provided herein. The terms ML, AI/ML and AIML may be used interchangeably and still be consistent with examples provided herein.

A WTRU may determine the validity or accuracy of an AI/ML model. The WTRU may be configured with resources on which to perform measurements to determine the validity of an AI/ML model. The resources may be in one or more frequency regions. For example, an AI/ML model may take inputs from a first frequency region to determine behavior in a second frequency region. To determine the validity of the AI/ML model, the WTRU may be configured with measurement resources in a first frequency region or a second frequency region.

The WTRU may determine whether the second frequency region behavior determined from the AI/ML model matches the second frequency region behavior determined from measurement resources in the second frequency region. In an example, the WTRU may be configured with periodic or sparse reference signals in the second frequency region to perform a legacy, for example, non-AI/ML based, method and to compare that with the output of the AI/ML model, which may be based on reference signals in a first frequency region.

The validity or accuracy of an AI/ML model may be determined by at least one of: the performance of an associated function, the statistical performance of an associated function, the performance of transmission in the frequency region of the function associated with the AI/ML model, a comparison of a legacy outcome to an AI/ML outcome, a measurement and/or a failure counter. In examples, the validity or accuracy of an AI/ML model may be determined by the performance of an associated function.

For example, the AI/ML model may be used to support or provide feedback or enable a function. The function may include one or more of beam management, CSI reporting, RLM, Beam Failure Detection, persistent listen-before-talk (LBT) failure, mobility, cell (re) selection, Random Access, or measurement reporting. A WTRU may determine the validity of an AI/ML model based on the performance of an associated function. A WTRU may be configured with a metric to determine the performance of an associated function. For example, a WTRU may be configured with an AI/ML model supporting beam management. The WTRU may be configured with a metric such as best beam determination. If the AI/ML model determines the best beam, the AI/ML model may be deemed valid.

The validity metrics associated with beam management may include at least one of the following. The metrics may include a best beam prediction. For example, the AI/ML model predicts the best beam. The metrics may include a predicted beam measurement within threshold offset from best beam. In an example, the threshold may be configurable. In another example, the threshold offset may be used to compare RSRP measurements. The metrics may include N predicted best beams match at least M actual best beams. The metrics may include a rate of beam failure detection.

In examples, the validity or accuracy of an AI/ML model may be determined by the statistical performance of an associated function. For example, the WTRU may deem an AI/ML model if it satisfies the associated function's metric in percentage of occasions in a time period.

In examples, the validity or accuracy of an AI/ML model may be determined by the performance of transmission in the frequency region of the function associated with the AI/ML model. For example, a WTRU may determine the validity of an AI/ML model with an associated function in a second frequency region based on the performance of transmissions in the second frequency region. The performance of transmissions may be determined based on at least one of: BLER, hypothetical PDCCH BLER, HARQ-ACK/negative ACK (NACK) performance or ratio, latency, throughput, spectral efficiency, outage probability and the like.

In examples, the validity or accuracy of an AI/ML model may be determined by a comparison of a legacy, for example, non-AI/ML based, outcome to an AI/ML outcome. For example, a WTRU may perform measurements in the frequency region of the associated function to compare with the output of an AI/ML model. The WTRU may determine the validity of an AI/ML model based on the difference between the output of the AI/ML model and the output of the associated function based on measurements in the applicable frequency region for example, using legacy methods.

In examples, the validity or accuracy of an AI/ML model may be determined by measurements. For example, the WTRU may determine the validity based on a measurement performed on an RS. The measurements may include at least one of: RSRP, RSSI, RSRQ, CSI, CQI RI, PMI, LI, CRI, channel occupancy (CO), probability of LOS, Doppler shift, Doppler spread, average delay, or delay spread. A WTRU may compare at least one measurement to one or more thresholds to determine the accuracy or validity of a model.

In examples, the validity or accuracy of an AI/ML model may be determined by a failure counter. The WTRU may count the number of times an AI/ML model failed. For example, the WTRU may count the number of times an associated function of an AI/ML model failed. In another example, the WTRU may count the number of times a prediction is off by more than a (possibly configurable) threshold value. The counter may be valid for a period of time. At the end of the period of time, the counter may be reset. The period of time may be fixed or configurable. The WTRU may start or restart the period of time when a failure occurs.

A WTRU may stop a period of time or may reset a counter when N (where N is configurable) outputs of the AI/ML model are deemed accurate, for example, a prediction is within a configurable threshold value from the actual value. A WTRU may determine the accuracy or validity of an AI/ML model based on the counter value when a period of time elapses. In another example, a WTRU may determine the accuracy or validity of an AI/ML model based on the failure counter reaching a specific value. For example, if the failure counter reaches X, the WTRU may consider the model non valid.

A WTRU may report the validity of an AI/ML model to the base station or gNB. The WTRU may report one of two states: valid or not valid. In another example, the WTRU may report an accuracy metric of an AI/ML model. The accuracy metric may indicate a validity value for an AI/ML model. The validity value may provide an accuracy parameter of the AI/ML model.

The validity of an AI/ML model may be reported in a PUCCH resource, a PUSCH resource, a RACH, an RRC message or a MAC CE. The validity of an AI/ML model may be reported using a new message. In another example, the validity of an AI/ML model may be reported, for example, implicitly, by the WTRU indicating failure of an associated function, for example, beam failure detection. Such a failure report may include a new element indicating that the cause of the failure is due to an AI/ML model no longer being valid.

A WTRU may request resources, for example, DL reference signals, to determine the validity of an AI/ML model. The WTRU may indicate to the base station or gNB the type of resource required, the AI/ML model, for example, AI/ML model index, the associated function.

A WTRU may be configured to determine the accuracy of an AI/ML model. The configuration may include a set of periodic time instances when the WTRU may determine the accuracy of an AI/ML model. The configuration may also include report resources, for example, associated to one or more periodic time instances, so that the WTRU may report the accuracy of the AI/ML model.

A WTRU may also be dynamically triggered to determine, and possibly report, the accuracy of an AI/ML model. The WTRU may receive the trigger in a DL signal such as a DCI, MAC CE or RRC command. The WTRU may be configured with one or more triggers to determine the accuracy of an AI/ML model.

A WTRU may be triggered to determine the accuracy of an AI/ML model by at least one of time, a timer, reception of an RS signal, an indication from the base station or gNB, performance of a function associated with the AI/ML model, performance of transmission in the frequency region of the function associated with the AI/ML model, Beam Failure Detection or Radio Link Failure determination, activation or deactivation of a cell, change of BW, change of cells, measurements, and/or a failure counter.

In examples, a WTRU may be triggered to determine the accuracy of an AI/ML model by time. For example, a WTRU may be triggered to determine the accuracy of an AI/ML model at specific time instances, for example, slots, subframes or symbols.

In examples, a WTRU may be triggered to determine the accuracy of an AI/ML model by a timer. For example, a WTRU may be triggered to determine the accuracy of an AI/ML model upon a timer elapsing, or after a set number of time instances or slots or subframes or symbols. The WTRU may start or restart a timer after determining the accuracy of an AI/ML model. The WTRU may start or restart the timer based on signaling from the base station or gNB. The WTRU may start or restart the timer based on the performance of a function associated with the AI/ML model. For example, if the AI/ML model is used for beam prediction, the WTRU may start or restart the timer if the prediction is determined to be within a required range.

In examples, a WTRU may be triggered to determine the accuracy of an AI/ML model by reception of an RS signal. For example, the WTRU may be triggered to determine the accuracy of an AI/ML model based on the reception of an RS intended for AI/ML model accuracy determination.

In examples, a WTRU may be triggered to determine the accuracy of an AI/ML model by performance of a function associated with the AI/ML model. For example, if the AI/ML model is used for beam prediction, the WTRU may be triggered to determine the accuracy of the AI/ML model if the prediction is determined to be outside of an acceptable range. Other example of performance of a function associated with the AI/ML model from the section on determination of validity or accuracy of an AI/ML model, may be applicable here.

In examples, a WTRU may be triggered to determine the accuracy of an AI/ML model by performance of transmission in the frequency region of the function associated with the AI/ML model. For example, a WTRU may be triggered to determine the validity or accuracy of an AI/ML model with an associated function in a second frequency region based on the performance of transmissions in the second frequency region. The performance of transmissions may be determined based on at least one of: BLER, hypothetical PDCCH BLER, HARQ-ACK/NACK performance or ratio, latency, throughput, spectral efficiency, outage probability and the like.

In examples, a WTRU may be triggered to determine the accuracy of an AI/ML model by a change of cells. In an example, the change of cells may be from cell handover (HO). In another example, the change of cells may be from cell selection. In a further example, the change of cells may be from cell reselection.

In examples, a WTRU may be triggered to determine the accuracy of an AI/ML model by measurements. For example, the WTRU may be triggered to perform determination of accuracy of an AI/ML model based on a measurement on an RS. The measurements may include at least one of: RSRP, RSSI, RSRQ, CSI, CQI RI, PMI, LI, CRI, CO, probability of LOS, Doppler shift, Doppler spread, average delay, or delay spread.

In examples, a WTRU may be triggered to determine the accuracy of an AI/ML model by a failure counter. The WTRU may count the number of times an AI/ML model failed. For example, the WTRU may count the number of times an associated function of an AI/ML model failed. In another example, the WTRU may count the number of times a prediction is off by more than a (possibly configurable) threshold value. The counter may be valid for a period of time. At the end of the period of time, the counter may be reset. The period of time may be fixed or configurable. The WTRU may start or restart the period of time when a failure occurs.

A WTRU may stop a period of time or may reset a counter when N (where N is configurable) outputs of the AI/ML model are deemed accurate, for example, a prediction is within a configurable threshold value from the actual value. A WTRU may be triggered to perform determination of accuracy of an AI/ML model based on the counter value when a period of time elapses. In another example, a WTRU may be triggered to perform determination of the accuracy or validity of an AI/ML model based on the failure counter reaching a specific value. For example, if the failure counter reaches X, the WTRU may be triggered to perform determination of accuracy of an AI/ML model.

In examples, a WTRU may engage in behavior as follows upon determining the accuracy of an AI/ML model. A WTRU may determine an appropriate behavior based on the determined accuracy or validity of an AI/ML model. The WTRU behavior may depend on the method used to determine the accuracy or validity of an AI/ML model. The WTRU behavior may be determined as a function of one or more or a combination of measurements or measurements compared to threshold values. The measurements may be triggered based on the determination of accuracy or validity of the AI/ML model. The measurements may include at least one of: BLER, hypothetical PDCCH BLER, RSRP, RSSI, RSRQ, CSI, CQI RI, PMI, LI, CRI, CO, probability of LOS, Doppler shift, Doppler spread, average delay, or delay spread. The WTRU behavior may include at least one of: continue using the AI/ML model, select a secondary output of the AI/ML model, update or train the AI/ML model, and/or stop using the AI/ML model and use or fallback to the legacy method of the associated function.

Examples herein include where the WTRU behavior includes continuing to use the AI/ML model. For example, if an AI/ML model is deemed accurate or valid, the WTRU may continue using it. The WTRU may deem an AI/ML model accurate if its accuracy is greater than a threshold value.

Examples herein include where the WTRU behavior includes selecting a secondary output of the AI/ML model. For example, if an AI/ML model is deemed to be accurate on average but incorrect for a specific outcome, the WTRU may select a secondary output, if available.

As an example, if for a predicted beam resource in FR2, the probability of LOS is higher than a first threshold, for example, LOS_th, and the derived CQI is lower than respective threshold, for example, CQI_th, the WTRU may update or retrain the AI/ML model. As another example embodiment, if for a predicted beam resource in FR2, the probability of LOS is lower than a first threshold, for example, LOS_th, and the derived CQI is lower than respective threshold, for example, CQI_th, the WTRU may determine to either select a secondary output of the AI/ML model or fall back to legacy operation, for example, based on determined probability of LOS.

The ML model for beam selection and/or prediction may be at the WTRU and/or the network. In a first exemplary solution where the ML model is at the WTRU, the WTRU may be configured with one or more use cases, which may include for example, one or more subsets of use cases, for which the ML model may be used. The WTRU may also be configured to make and possibly report measurements to determine whether the ML model is suitable for use. Use cases/parameters determining whether the WTRU may use the ML model may include any one or more of the following: indication/probability of LOS/NLOS, a change in LOS/NLOS indication/probability, signal-to-noise ratio (SNR)/SINR measurements/computation, additional channel measurements or change in channel measurements, a supported number of FR1 and FR2 beams, a change in bandwidth part (BWP), WTRU capabilities, network assistance, antenna panel configurations at the WTRU, other antenna parameters, and/or model validity/accuracy.

Examples are provided herein including the WTRU using indication/probability of LOS/NLOS to determine whether to use the ML model. In an example, the base station or gNB may configure multiple beams in a first frequency range, for example, FR1, to find the one with the best probability of LOS such that the chances of exceeding pre-configured LOS probability are higher. In such scenarios, the WTRU may only use the FR1 beams with the best LOS probabilities, such as above the pre-configured threshold, as input to the ML model.

In an example, the WTRU may determine that LOS indication is negative or LOS probability is below a pre-configured threshold for any of the CSI-RS resources. The WTRU may determine to deactivate the AI/ML model and resort to legacy beam management procedures. In an example, the WTRU may make the determination based on historical poor performance of ML model in NLOS scenarios previously observed by the WTRU.

Examples are provided herein including the WTRU using a change in LOS/NLOS indication/probability to determine whether to use the ML model. In an example, the WTRU may determine to activate/deactivate the ML model based on the change in LOS/NLOS conditions. For example, if the LOS indication went from “1” to “0” indicating a loss of LOS, the WTRU may determine to deactivate the ML model and switch back to legacy beam management procedures.

In another example, the WTRU may measure a sudden drop in LOS/NLOS probabilities. A drop below a threshold preconfigured by WTRU or base station, or gNB, may trigger the WTRU to deactivate usage of the ML model and switch to legacy beam management procedures.

Examples are provided herein including the WTRU using SNR/SINR measurements/computation to determine whether to use the ML model. The WTRU may be configured to make/compute SNR/SINR measurements, for example, SS-SINR, CSI-SINR. The WTRU may determine to deactivate the ML model for FR2 beam selection based on a drop in SNR/SINR measurements/computation below a configured or preconfigured threshold. The threshold may also be based on a drop/difference in SNR/SINR value instead of the absolute value such that a drop/difference exceeding the threshold may be the trigger for the WTRU to switch to legacy procedures, which may be legacy beam management procedures, in an example.

In another example, the WTRU may be configured with SNR/SINR ranges where the use of a second frequency range, for example, FR2, ML selection/prediction model provides the best output for beams prediction based on measurements input in a first frequency range, for example, FR1.

Measurements/computation of SNR/SINR outside of preconfigured range may trigger the WTRU to deactivate the ML model and revert to the traditional framework, which may be a traditional beam management framework, in an example.

Examples are provided herein including the WTRU using additional channel measurements, for example, Channel coherence time, Channel coherence bandwidth, Doppler spread, BLER, and the like, or change in channel measurements to determine whether to use the ML model. The WTRU may perform additional channel measurements, for example, Channel coherence time, Channel coherence bandwidth, Doppler spread, BLER, and the like. Measured values and/or changes in measured values of the channel conditions may constitute a trigger to use or not to use the ML model.

In an example, WTRU measuring and recording of a large channel coherence time, such as beyond a configured or preconfigured threshold, may signify a slow-fading channel, leading the WTRU to activate the ML model predicting the best FR2 beam based on FR1 beam information/measurements. In another example, a channel coherence time lower than a preconfigured threshold may result in poor performance of the FR2 prediction model due to fast-fading conditions. In this case, the WTRU may deactivate the model and resort to traditional methods of FR2 beam selection.

In an example, the WTRU may measure a sudden change in any one of the channel parameters, for example, Channel coherence time, Channel coherence bandwidth, Doppler spread, BLER, and the like. In an example, a change in channel coherence time from a large, measured value to a smaller value may signify a sudden degradation in channel conditions such that the WTRU may determine that the channel conditions are no longer valid/stable enough to use the FR2 beam ML predictor, and hence revert/fallback to legacy methods of FR2 beam selection.

In an example, the WTRU may be configured with corresponding ranges for any one of the channel parameters, for example, Channel coherence time, Channel coherence bandwidth, Doppler spread, BLER, and the like, such that the WTRU may determine to only activate the FR2 beam selection/prediction ML model when the channel measurements are within the configured/preconfigured/determined ranges.

Examples are provided herein including the WTRU using a supported number of FR1 and FR2 beams to determine whether to use the ML model. The WTRU may activate/deactivate the ML model based on the supported number of beams in the first and second frequency ranges. In an example, a lower number of supported beams in a second frequency range, for example, FR2, may trigger the WTRU to deactivate the beam ML model for prediction in the second frequency range for example, FR2, as the WTRU may determine that with a smaller number of supported beams, the legacy measurement methods select the best FR2 beam. In such a scenario, the minimum number of supported beams in the second frequency range, for example, FR2, that would trigger usage of the ML model may be determined by the WTRU through historical data, for example, past validation of the ML model accuracy assessed against number of supported FR2 beams.

Examples are provided herein including the WTRU using a change in BWP to determine whether to use the ML model. A WTRU may determine to deactivate an ML model following a change/switch in BWP. In an example when the WTRU changes/switches BWP due to timer expiration, the WTRU may determine that the model is no longer suitable for the new BWP.

Examples are provided herein including the WTRU using WTRU capabilities to determine whether to use the ML model. A WTRU may determine to use ML model based on WTRU capabilities. In one example, a reduced-capability WTRU and/or a non-ML capable WTRU may not be configured with any ML model and may have to use legacy methods, such as legacy methods of beam selection. In another example, a lesser capable WTRU may be able to use an ML model for current beam selection/determination in a second frequency range, for example, FR2, based on beam measurement in a first frequency range for example, FR1, but may not be able to predict future beams based on current measurements as a result of the WTRU making less measurements, for example, as compared to the larger number of measurements a WTRU with four (4) receive antennas would make. In an example, a lesser capable WTRU may be a WTRU with two (2) receive antennas as compared to four (4) receive antennas.

Examples are provided herein including the WTRU using network assistance to determine whether to use the ML model. The network may send assistance to the WTRU in terms of indications of when the WTRU can activate its ML model. During registration, the network may send “WTRU Capability Enquiry” to the WTRU to specify which capability it wants the WTRU to report. One such capability can be whether the WTRU is ML-capable or not. The indication may be a single bit/flag type indicator where the WTRU would report a “1” if it is configured with an ML model and a “0” otherwise or it may have additional parameters reported, for example, SNR range for which the ML model is activated at the WTRU. Based on a base station's or gNB's measurements, such as on, for example, channel conditions, assistance may be provided to the WTRU on when to activate respective ML model.

Examples are provided herein including the WTRU using antenna panel configurations at the WTRU to determine whether to use the ML model. In an example, the antenna panel configurations between antenna ports in a first and second frequency ranges may not be compatible such that measurements made in the first frequency range, for example, FR1, may not result in selection of the best beam the second frequency range, for example, FR2. For example, there may not be the same QCL type D assumptions between antenna ports and/or panels for the different frequency ranges, such as at the WTRU side. The WTRU may determine to deactivate ML prediction model and revert/fallback to legacy procedures, such as legacy beam selection procedures.

Examples are provided herein including the WTRU using other antenna parameters to determine whether to use the ML model. A WTRU may determine to activate/deactivate/retrain its ML model based on other antenna parameters, for example, one or more of, a Boresight of antenna array, beam direction of antennas, or antenna array configuration for the first and/or the second frequency ranges at the WTRU and/or a base station or gNB. In an example, a change in the boresight of the antenna array or the beam direction of antennas may trigger the WTRU to deactivate its ML model, for example, because the model may require retraining for the new beam direction.

Examples are provided herein including the WTRU using model validity/accuracy to determine whether to use the ML model. The WTRU may activate/deactivate the ML model based on model validity/accuracy which the WTRU can determine through any of the methods as explained elsewhere in embodiments and examples herein. The activation/deactivation of the ML model can be triggered by any of the triggers as explained elsewhere in embodiments and examples herein.

In any use case involving determination that one method of beam selection/prediction is no longer valid leading to another method of beam selection/prediction, for example, switching from ML model to legacy (beam management) procedures, the WTRU may be configured with a procedure for a smooth transition. In an example, the transitory procedure may involve triggering of a time window after the WTRU determines to transition to legacy procedures to allow time for measurements to be made/sent/reported to the base station or gNB, for example, SS and/or CSI-RS measurements and/or SRS, before the ML model is deactivated.

In an exemplary solution where the ML model is at the base station or the gNB, the WTRU may provide feedback/report to the base station or the gNB, for example, in UCI, on the accuracy/quality of the beam selected by the base station or the gNB. Following feedback from the WTRU, the base station or the gNB may determine whether to keep using the ML model for beam selection/prediction, to deactivate the ML model, to retrain the ML or to revert/fallback to legacy/non-ML methods, such as for beam selection.

In an example, the WTRU may be configured to perform RSRP measurements on the beam selected by the ML model in the second frequency range, for example, FR2, at the base station or the gNB, which may be based on input/reported data/information in the first frequency range, for example, FR1, from the WTRU. If the WTRU measures an RSRP value below a threshold, the WTRU may report the measurements to the base station or the gNB which may fall back to legacy (beam management) procedures. In an example, the threshold may be one or more of configured, preconfigured, determined or predetermined by the WTRU or the base station or the gNB.

In an example, the WTRU may be configured to perform additional measurements when ML model is used at the base station or the gNB, especially at the beginning of the validation period to make sure that the ML model at the base station or the gNB is well-calibrated. The WTRU may be configured to report all channel measurements or only report channel measurements when they are above/below (pre) configured/determined thresholds by the network or only report changes in channel measurements below/above (pre) configured/determined thresholds.

Embodiments and examples are provided herein of dynamic re-training/updating of AI/ML models. Further, examples are provided herein of iterative re-training/updating of AI/ML model based on AI/ML predicted beam output.

Examples are provided herein of AI/ML model configuration aspects. A WTRU may be configured with an AI/ML model to perform prediction of beam resource(s) and/or properties of beam resource(s) associated with a second frequency band, for example, FR2)-based on beam resource(s) and/or properties of beam resource(s) in a first frequency band, for example, FR1. Herein a beam resource may consist of a TCI state, CSI-RS or an SSB for downlink, an SRS resource or a TCI state for uplink. Herein property of beam resource may be any CSI associated with beam resource including but not limited to CQI, PMI, RI, RSRP, SNR, SINR, LOS or NLOS information, CIR or any statistic associated thereof and the like. In an example solution, the WTRU may apply as input to the AI/ML model measured FR1 beam resource properties and obtain as an output the best beam resource(s) and/or beam resource(s) property associated with FR2. In an example, first frequency band, for example FR1, beam resource properties may include one or more of RSRP, CSI, PMI, CIR, LOS probability or the like.

In an example solution, the WTRU may be configured to report the output of the AI/ML model to the base station or gNB. For example, the WTRU may measure FR1 beam resources, apply as input to the AI/ML model, obtain the predicted RSRP of FR2 beam resources as output from the AI/ML model and report the predicted RSRP of FR2 beam resources to the base station or gNB.

Examples are provided herein of monitoring/validating accuracy of an AI/ML models. A WTRU may be configured to determine the accuracy of the AI/ML model. The mechanism to determine the accuracy of the AI/ML model may depend on the specific function that the AI/ML model may support. For example, the function may be beam management, CSI feedback generation, beam failure and/or radio link failure determination, mobility, measurement reporting etc. For example, the WTRU may compare the predicted values of FR2 beam resources, for example, from the output of the AI/ML model, with the actual values of the FR2 beam resources, for example, based on measurement of FR2 beam resources. Some example methods for determining accuracy of the AI/ML model are described in embodiments and examples elsewhere herein.

In an example solution, the WTRU may be configured with accuracy threshold for the operation of an AI/ML model. For example, such accuracy threshold may be configured semi-statically via RRC configuration. In a possible example, such accuracy threshold may be signaled as a part of AI/ML model configuration. In another example, the accuracy threshold may be signaled in a MAC control element. Possibly, such an accuracy threshold may be signaled along with the AI/ML model activation command. When the model is active, the WTRU may be configured to monitor the accuracy of the AI/ML model. Possibly, such monitoring may be performed over a preconfigured time period. In one example solution, if the accuracy of the AI/ML model does not meet preconfigured accuracy threshold, the WTRU may autonomously deactivate the AI/ML model and transmit a report to the network. Possibly, the WTRU may be configured to fallback to legacy method for the function performed by the AI/ML model. Possibly, the WTRU may initiate retraining of the AI/ML model.

In an example solution, a WTRU may be configured to perform retraining of the AI/ML model periodically. For example, the WTRU may be configured to start a timer with a preconfigured value. Upon expiry of the timer, the WTRU may trigger retraining of the AI/ML model. The WTRU may restart the timer upon completion of the retraining procedure. In another example solution, the WTRU may restart the timer when the AI/ML model retraining is successfully performed due to event-based triggers. The periodic AI/ML model retraining timer may be configured as part of AI/ML model configuration or configured as part of AI/ML model activation.

In another example solution, the WTRU may be configured to perform retraining of the AI/ML model based on preconfigured triggers. In an example solution, the triggers may be based on AI/ML model accuracy. For example, WTRU may be configured to determine accuracy of the AI/ML model based on one or more triggers as outlined in embodiments and examples provided elsewhere herein. If the determined accuracy is below a preconfigured accuracy threshold the WTRU may trigger retraining of the AI/ML model. In another example solution, the triggers may be based on AI/ML performance. For example, the WTRU may be configured to monitor the AI/ML model performance—for example, based on a metric associated with the function enabled by the AI/ML model. For example, the performance metric may include one or more of BLER performance on the reported FR2 beams above or below a threshold, HARQ-ACK, or HARQ-NACK ratio, L3 (e.g., RSRP, RSSI, RSRQ, CO) or L1 measurement (e.g., RI, PMI, CQI, LI, CRI, RSRP) or the like.

In another example solution, the triggers may be based on change in configuration aspect. For example, the configuration aspect may include RS configuration, bandwidth part configuration, SCell configuration, and the like. In yet another example solution, the triggers may be based on mobility events. For example, the mobility events may include change of serving cell/TRP due to HO/conditional handover (CHO)/dual active protocol stack (DAPS) handover, radio link failure (RLF), and the like. In an example solution, the trigger condition may be based on network command. For example, the WTRU may receive an implicit or explicit indication in a deactivation command associated with the AI/ML model, wherein the deactivation command may indicate that the WTRU should retrain the AI/ML model. In a possible example, the deactivation command may additionally indicate configuration of resources applicable for retraining.

Examples are provided herein of iterative procedures for training, retraining or both of AI/ML models. When one or more triggers for training, retraining, or both, of an AI/ML model are met, the WTRU may indicate to the network that a retraining procedure is triggered, additionally providing the reason for the retraining. For example, the reason may be expressed as a cause value and different code points in the cause value may be associated with different trigger conditions. In a possible example, the indication may include an AI/ML performance and/or accuracy value. Possibly, the WTRU may include assistance information to enable the network to configure resources for retraining. For example, the assistance information may include one or more of the following: number of beams resources for retraining, periodicity, density of RSs in frequency domain, or the like.

A WTRU may train, retrain, or both, an AI/ML model based on configuration parameters received from the base station or gNB. For example, such configuration parameters may include one or more of the following: configuration of FR1 beam resource(s), configuration of FR1 beam resource(s) properties, configuration of FR2 beam resource(s), configuration of FR2 beam resource(s) properties, configuration of a loss function including parameterization, thresholds or the like. For example, loss function may be associated with a metric that indicates difference between predicted FR2 beam resource(s) and the actual FR2 beam resource(s) as a cross entropy loss, hinge loss, squared hinge loss, mean squared error, and the like.

In an example solution, WTRU may determine that the retraining is successful based on preconfigured criteria and indicate retraining completion to the base station or gNB. For example, the WTRU may determine that the retraining is complete when the accuracy of the AI/ML model after retraining is above a preconfigured threshold.

In an example solution, the WTRU may be configured to iteratively retrain the model until the AI/ML model output is updated. For example, the WTRU may be configured to use the measured CSI parameters, for example, CQI, PMI, CIR, and the like, in retrained/updated beam prediction the AI/ML model, and may determine one or more best FR2 beams, for example, based on RSRP. The WTRU may determine that the retraining is complete when the re-training of the model has resulted in different output, for example, different predicted FR2 beams than the AI/ML model before retraining. The WTRU may be configured indicate the retraining success to the network via a MAC control element, a preconfigured PUCCH resource or a preamble resource. The WTRU may optionally indicate the accuracy value of the AI/ML model in the retraining success indication.

In an example solution, the WTRU may determine that the retraining is unsuccessful based on preconfigured criteria. For example, the WTRU may declare retraining failure, if the retraining is not successful within a preconfigured time period. For example, the WTRU may declare retraining failure, if the AI/ML model accuracy does not become better than a preconfigured accuracy threshold. For example, the WTRU may declare retraining failure if the model output before and after re-training results in the same output, for example, the same predicted FR2 beams. For example, the WTRU may declare retraining failure if the beam resources configured for the training are no longer available, for example, the beam resources may be released/deactivated by the network or due to blockage or WTRU mobility, and the accuracy of the AI/ML model is still below preconfigured accuracy threshold. Upon retraining failure, the WTRU may deactivate the AI/ML model (if active) and fallback to a conventional beam management mechanism. The WTRU may be configured to transmit a retraining failure indication to the network via a MAC control element. In another example solution, the WTRU may transmit a retraining failure indication via a preconfigured PUCCH resource or a preconfigured preamble resource.

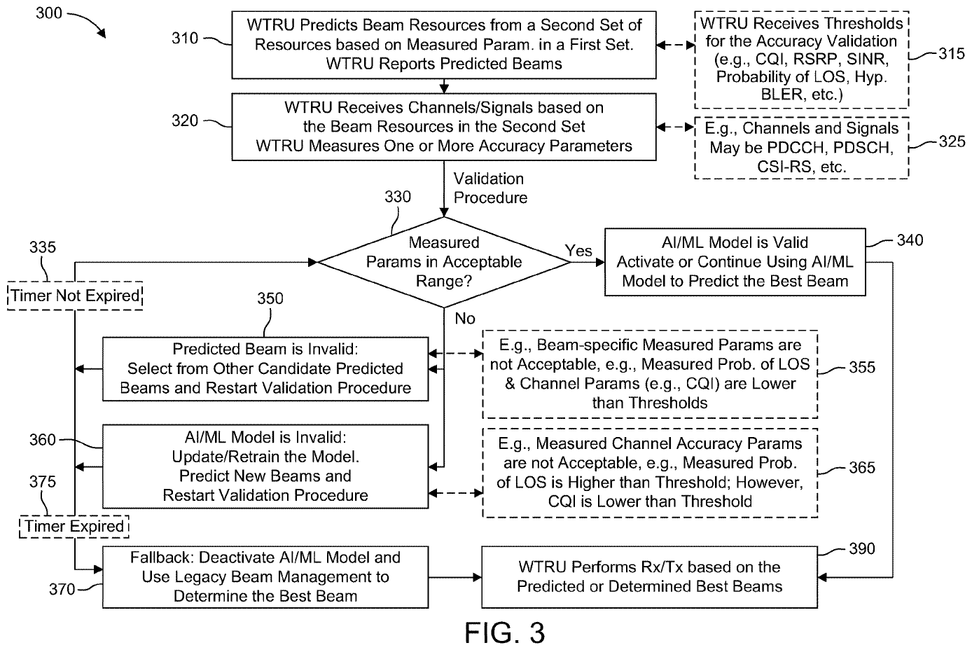

FIG. 3 is a flowchart diagram illustrating an example of a validation procedure for beam prediction based on hierarchical spatial relations. In an example shown in flowchart diagram 300, a WTRU may perform measurements on parameters of a first set of beam resources, and the WTRU may then predict beam resources from a second set of beam resources based on the measured parameters of the first set of beam resources 310. In an example, a base station may transmit to the WTRU using the first set of beam resources. The WTRU may then report the predicted beam resources. The WTRU may report these predicted beam resources to the base station, in an example.

In a further example, the WTRU may receive one or more thresholds for accuracy validation 315. These thresholds may be used when measuring the first set of beam resources. In examples, the thresholds for accuracy validation may include one or more of a CQI threshold, an RSRP threshold, an SINR threshold, a probability of LOS threshold, a hypotheical BLER threshold, and the like. The WTRU may receive the one or more thresholds from the base station, in an example.

Further, the WTRU may receive one or more signals on one or more channels base on the beam resources in the second set of beam resources 320. Also, the WTRU may measure one or more accuracy parameters of the one or more signals. The WTRU may receive the one or more signals from the base station, in an example.

The one or more signals may include one or more PDCCH signals, in an example 325. Also, the one or more signals may include one or more PDSCH signals. In another example, the one or more signals may include one or more CSI-RSs. Similar signals may also be recieved in other examples. Further, the one or more channels may include one or more PDCCHs. Additionally, the one or more channels may include one or more PDSCHs. Similar channels may also be used for reception in other examples.

The WTRU may further perform the validation procedure and determine whether the one or more measured accuracy parameters are in an acceptable range 330. If the one or more measured accuracy parameters are in the acceptable range, the WTRU may determine that an AI/ML model is valid 340. Further, upon the determination that the AI/ML model is valid, the WTRU may activate use of the AI/ML model to predict the best beam. In an additional or alternative example, upon the determination that the AI/ML model is valid, the WTRU may continue use of the AI/ML model to predict the best beam. Further, the WTRU may perform transmission, reception, or both based on the predicted for determined best one or more beams 390.

If the one or more measured accuracy parameters are not in the acceptable range, the WTRU may determine that the predicted beam is invalid 350. Further, the WTRU may select, from one or more other candidates, one or more other predicted beams. Moreover, the WTRU may restart the validation procedure. In an example, the beam-specific accuracy parameters may not in the acceptable range because the measured probability of one or more LOS parameters are lower than an LOS threshold and one or more channel parameters are lower than a channel parameter threshold 355. The one or more channel parameters may include one or more CQI parameters in an example.

If the WTRU restarts the validation procedure 350, and a timer has not expired 335, the WTRU may again determine whether the one or more measured accuracy parameters are in an acceptable range 330. The WTRU may then continue using the validation procedure. If the timer has expired 375, the WTRU may fallback to legacy beam management 370.

During the validation procedure, if the one or more measured accuracy parameters are not in the acceptable range, the WTRU may determine that the AI/ML model is invalid 360. Further, the WTRU may then update the AI/ML model, retrain the AI/ML model, or do both. Also, the WTRU may predict new beams. Moreover, the WTRU may restart the validation procedure. In an example, the beam-specific accuracy parameters may not in the acceptable range because the measured probability of one or more LOS parameters are higher than an LOS threshold, however one or more channel parameters are lower than a channel parameter threshold 365. The one or more channel parameters may include one or more CQI parameters in an example.

If the WTRU restarts the validation procedure 360, and a timer has not expired 335, the WTRU may again determine whether the one or more measured accuracy parameters are in an acceptable range 330. The WTRU may then continue using the validation procedure. If the timer has expired 375, the WTRU may fallback to legacy beam management 370.

If the WTRU fallbacks to legacy beam management, the WTRU may deactivate the AI/ML model and then use legacy beam management to determine the best beam 370. Further, the WTRU may perform transmission, reception, or both based on the predicted for determined best one or more beams 390.

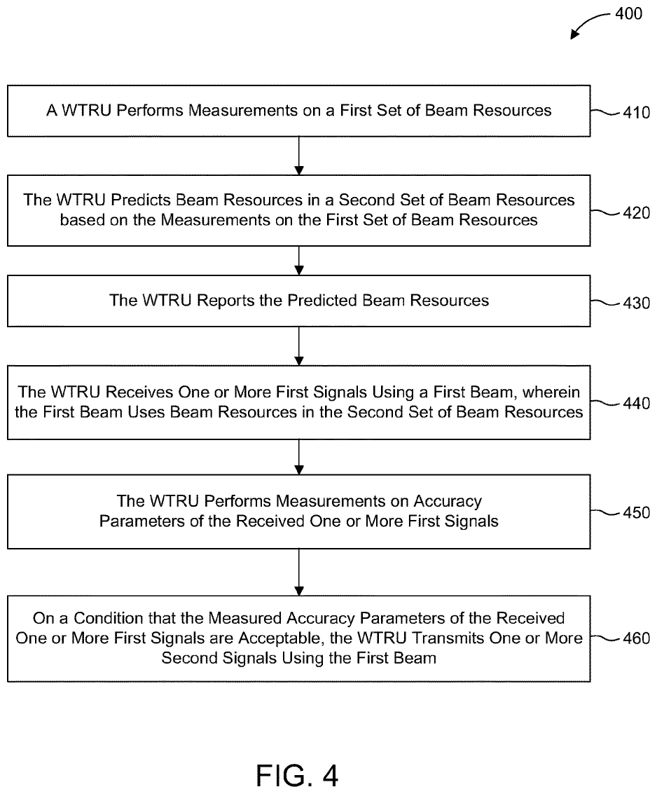

FIG. 4 is a flowchart diagram illustrating an example of predicted beam management. In an example shown in flowchart diagram 400, a WTRU may perform measurements on a first set of beam resources 410. A base station may transmit to the WTRU using the first set of beam resources, in an example. In an example, the first set of beam resources may be FR1 beam resources. The WTRU may then predict beam resources in a second set of beam resources based on the measurements on the first set of beam resources 420. The second set of beam resources may be FR2 beam resources, in an example. Further, the WTRU may report the predicted beam resources 430. In an example, the WTRU may report the predicted beam resources to the base station.

Moreover, the WTRU may receive one or more first signals using a first beam 440. The WTRU may receive the one or more first signals from the base station, in an example. In an example, the first beam may use beam resources in the second set of beam resources.

Also, the WTRU may perform measurements on one or more accuracy parameters of the received one or more first signals 450. Further, on a condition that the measured one or more accuracy parameters of the received one or more first signals are acceptable, the WTRU may transmit one or more second signals using the first beam 460. The accuracy parameters may be acceptable when a measured LOS is higher than an LOS threshold and a CQI is higher than a CQI threshold, in an example. In an example, the WTRU may transmit the one or more second signals to the base station.

In a further example, the WTRU may receive one or more third signals using the first beam, on a condition that the measured one or more accuracy parameters of the received one or more first signals are acceptable. The WTRU may receive the one or more third signals from the base station, in an example.

In an example, the received one or more first signals may be a PDCCH signal. In another example, the received one or more first signals may be a CSI-RS.

Moreover, using the first beam may include activating the first beam, in an example. In another example, using the first beam may include continuing to use the first beam.

In a further example, the one or more accuracy parameters may include one or more line of sight (LOS) parameters. In another example, the one or more accuracy parameters may include one or more channel parameters. Also, the one or more accuracy parameters may include one or more CQI parameters.

In an additional example, the WTRU may also activate an AI/ML model to predict one or more second beams. The one or more second beams may use beam resources in the second set of beam resources, in an example. In an additional example or an alternative example, the WTRU may continue to use the AI/ML model to predict one or more second beams.

In an additional example, the WTRU may transmit a request to select and report a third beam, on a condition that the measured one or more accuracy parameters of the received one or more first signals are not acceptable. The measured LOS may be lower than an LOS threshold and the measured CQI may be lower than a CQI threshold, in an example. In an example, the WTRU may transmit the request to the base station. In a further example, the base station may respond to the request. As a result, the WTRU may select the third beam. Further, the WTRU may report the third beam to the base station.

In another example, the WTRU may transmit a request on a condition that the measured one or more accuracy parameters of the received one or more first signals are not acceptable. In an example, the measured LOS may be higher than an LOS threshold and the measured CQI may be lower than a CQI threshold. The transmitted request may include a request to update an AI/ML model. The transmitted request may include a request to retrain the AI/ML model. Further, the transmitted request may include a request to use the AI/ML model to predict a fourth beam and report the fourth beam. In an example, the WTRU may transmit the request to the base station. Further, in an example, the base station may respond to the request. As a result, the WTRU may update the AI/ML model. In an additional example or an alternative example, the WTRU may retrain the AI/ML model. Also, the WTRU may use the AI/ML model to predict the fourth beam. Further, the WTRU may report the fourth beam. In an example, the WTRU may report the fourth beam to the base station.

Moreover, the WTRU may fall back to a non-AI/ML beam management procedure to select and report a fifth beam, on a condition that the measured one or more accuracy parameters of the received one or more first signals are not acceptable. In an example, the measured CQI may be lower than a CQI threshold, and a number of time instances may have passed since the reception of the first signals using the first beam. In an example, the WTRU may then select the sixth beam. Further, the WTRU may report the sixth beam. In an example, the WTRU may report the sixth beam to the base station.

In a further example, the WTRU may receive one or more fourth signals using one or more sixth beams, and may measure one or more accuracy parameters of the received one or more fourth signals, on a condition that the measured one or more accuracy parameters of the received one or more first signals are not acceptable. In an example, the measured LOS may be lower than an LOS threshold, the measured CQI may be lower than a CQI threshold, and a number of time instances may have not passed since the reception of the first signals using the first beam. The WTRU may receive the one or more fourth signals from the base station, in an example.

Examples are provided herein of dynamic re-training/updating of AI/ML models based on changes in the activation/deactivation set of TCI states. The TCI states provide QCL information necessary for WTRUs to receive various reference signals and/or channels. A WTRU may be configured with several TCI states, for example, by RRC signaling, and out of which a subset of configured TCI states can be activated via signaling, such as, for example, MAC-CE signaling. To receive a reference signal, a channel, or both a WTRU may select at least one TCI state out of an activated set of TCI states, for example, based on DCI, an indication or following a (predefined) configuration, for example, in case of using a default QCL assumption to receive a DM-RS of a PDSCH when the scheduling offset is less than (<) timeDurationForQCL. A WTRU may activate a new set of TCI states upon the reception of a new signaling/indication, for example, via a MAC-CE.

For example, the change of the set of activated TCI states can be seen as an indication of change of the radio wave propagation environment due to various factors, for example due to rotation, movement, or both, of the WTRU, or change of other objects in the surrounding environment. Thus, when the set of activated TCI states of a WTRU changes, the WTRU may determine to evaluate the need for retraining the AI/ML model used for beam selection and/or prediction.

A WTRU may be configured and activated with a first set of TCI states by a first, for example, MAC-CE, indication when an AI/ML model for beam predication and/or selection is trained. After the AI/ML model training is performed, the WTRU may be activated with a second set of TCI states by a second, for example, MAC-CE indication. Upon the reception of the second, for example, MAC-CE, signaling indicating the activation of second set of TCI states, the WTRU may determine the need for retraining AI/ML model and/or evaluate and indicate the need for retraining the AI/ML model to the base station or gNB. The need for retraining the AI/ML model may be reported to the base station or gNB, for example, in a PUCCH resource, a PUSCH resource, a RACH, an RRC message or a MAC CE.

In an example solution, a WTRU may compare the first set of TCI states and the second set of TCI states and determine the level of overlap between the two sets (L_overlap). If L_overlap of the two sets is below a configured/preconfigured/determined threshold level, the WTRU may determine that the retraining of the AI/ML model is required. If L_overlap is higher than the configured/preconfigured/determined threshold level, the WTRU may determine that the retraining of the AI/ML model is not required. A WTRU may determine and/or receive the threshold value for TCI state overlap from the base station or gNB, for example, via RRC/MAC-CE signaling.

In another example solution, a WTRU may determine the number of new TCI states activated in the second set of TCI states that were not part of the first set (N_add) and/or the number of TCI states in the first set of TCI states that were not included in the second set (N_del). If N_add and/or N_del are above respective configured/preconfigured/determined thresholds, the WTRU may determine that the AI/ML model retraining is required. If N_add and/or N_del are below respective thresholds, the WTRU may determine that the AI/ML model retraining is not required. The WTRU may receive respective threshold value(s) for N_add and N_del from the base station or gNB, for example, via RRC/MAC-CE signaling.

In an additional or an alternative example solution, a WTRU may report one or more computed parameters L_overlap, N_add, and N_del to the base station or gNB. In an example, the WTRU may report one or more computed parameters as soft information. For example, the WTRU may report information regarding ‘the level of accuracy/validity/confidence.

Embodiments and examples are provided herein of AI/ML model beam prediction validation based on reciprocity. A WTRU may receive and measure one or more parameters, for example, CSI or beam parameters, for example, RSRP, CQI, PMI, SINR, and so forth, regarding one or more beam resources in a first frequency range, for example, FR1. The WTRU may determine/predict, for example, based on the AI/ML model, one or more beam resources in a second frequency range, for example, FR2, based on the respective measurements. A beam resource may consist of a TCI state, CSI-RS or a SSB for downlink, an SRS resource or TCI state for uplink. The WTRU may define/determine one or more spatial filters for the determined/predicted beam resources. The WTRU may identify the determined/predicted beam resources by a reference ID.

One of ordinary skill in the art will appreciate that one or more problems are addressed by embodiments and examples provided herein. For example, one problem addressed is how the determined/predicted beam resources in the second frequency range and the respective AI/ML model are validated.

In an example solution, a WTRU may perform one or more uplink transmissions, for example, SRS, PUCCH, PUSCH), wherein the WTRU may determine an association considering the spatial relation between (each of the) uplink transmissions and (one of) the determined/predicted (downlink) beam resources. As such, the WTRU may determine to use the spatial domain filter for the uplink transmissions that the WTRU may have determined for the associated determined/predicted beam resources. The WTRU may indicate the reference ID corresponding to the determined/predicted beam resource that is associated, in the context of spatial relation, with respective uplink transmission.

In an example, the WTRU may be scheduled/configured with one or more UL transmissions of signals and/or channels. As such, the WTRU may determine to transmit the configured UL signals or channels using the same spatial filter that may be defined for the determined/predicted beam resources. For example, the WTRU may determine to use the same spatial domain filter that is determined to transmit (uplink) the resource reference signals or channels on any of the determined beam resources, predicted beam resources, or both. In other words, the WTRU may determine to consider the same QCL relation between the determined/predicted (downlink) beam resources and the (uplink) transmitted signals or channels.

In an example solution, the base station or gNB may measure the parameters, beam resources, RSRP, CIR, angle of arrival (AoA), PDCCH Hypothetical BLER, and so forth, corresponding to the received uplink signals and channels. The base station or gNB may change, update, or confirm the determined beam resources, predicted beam resources or both.

The WTRU may receive one or more signaling, for example, via DCI, MAC CE, or the like, from a base station or gNB indicating if the base station or gNB has changed, updated, or confirmed the determined/predicted beam resources. In an example, the WTRU may receive a flag, for example, in DCI, indicating whether the predicted/determined beam resources are valid or invalid. For example, a flag value zero may be indicating invalid and flag value one may be indicating valid. In another example, the WTRU may receive one or more CSI-RS measurement and reporting configurations, for example, CSI-RS resources, QCL info, TCI-state, and the like, that may be based on the selected beam resources, such as at the base station or gNB.

The WTRU may receive one or more signals and channels in one or more beam resources, for example, in the second frequency range, based on the uplink transmitted/reported signals/channels, where the WTRU may use the received signals to measure the CSI and/or beam parameters. The WTRU may further use the measurements to update/retrain the AI/ML model. The WTRU may select and report the best beam and respective CSI quantities. The respective CSI quantities may include, for example, CSI-RSRP, CIR, and the like.

Although features and elements are described above in particular combinations, one of ordinary skill in the art will appreciate that each feature or element can be used alone or in any combination with the other features and elements. Also, one of ordinary skill in the art will appreciate that features and elements described above include means to perform the methods described herein. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-24. (canceled)

25. A method for use in a wireless transmit/receive unit (WTRU), the method comprising:
receiving first configuration information including a configuration of one or more reference signal (RS) resources for measurement and configuration of one or more RS resources for prediction;
receiving second configuration information including a configuration of one or more RS resources for validity;
performing measurements of the one or more RS resources for measurement;
determining a prediction of one or more best RS resources of the one or more RS resources for prediction based on the measurements of the one or more RS resources for measurement;
performing measurements of the one or more RS resources for validity;
determining one or more best RS resources of the one or more RS resources for validity based on the measurements of the one or more RS resources for validity;
on a condition that at least one RS resource from the prediction of the one or more best RS resources of the one or more RS resources for prediction corresponds to an RS resource of the one or more best RS resources of the one or more RS resources for validity, determining that the prediction of the one or more best RS resources of the one or more RS resources for prediction is a valid prediction; and
reporting the determination that the prediction of the one or more best RS resources of the one or more RS resources for prediction is a valid prediction.

26. The method of claim 1, wherein the determination that the prediction of the one or more best RS resources of the one or more RS resources for prediction is a valid prediction is performed over a preconfigured time period.

27. The method of claim 1, wherein the one or more RS resources for measurement are one or more RS resources for channel measurement.

28. The method of claim 1, wherein the one or more RS resources for validity are one or more RS resources for prediction accuracy.

29. The method of claim 1, wherein the one or more RS resources for measurement are one or more beam RS resources for measurement, the one or more RS resources for prediction are the one or more beam RS resources for prediction, and the one or more RS resources for validity are the one or more beam RS resources for validity.

30. The method of claim 1, further comprising:
reporting up to a configured number of RS resources from the prediction of the one or more best RS resources of the one or more RS resources for prediction.

31. The method of claim 1, wherein the one or more RS resources for measurement are in a first frequency range, and the one or more RS resources for prediction are in a second frequency range.

32. The method of claim 1, further comprising:
receiving information providing a correspondence between the one or more RS resources for prediction and the one or more RS resources for validity.

33. The method of claim 1, wherein the one or more best RS resources of the one or more RS resources for prediction have a highest reference signal received power (RSRP) from among the one or more RS resources for prediction.

34. The method of claim 1, wherein the one or more best RS resources of the one or more RS resources for validity have a highest RSRP from among the one or more RS resources for validity.

35. A wireless transmit/receive unit (WTRU) comprising:
a transceiver; and
a processor, operatively coupled to the transceiver; wherein:
the transceiver and the processor are configured to receive first configuration information including a configuration of one or more reference signal (RS) resources for measurement and configuration of one or more RS resources for prediction;
the transceiver and the processor are configured to receive second configuration information including a configuration of one or more RS resources for validity;
the transceiver and the processor are configured to perform measurements of the one or more RS resources for measurement;
the processor is configured to determine a prediction of one or more best RS resources of the one or more RS resources for prediction based on the measurements of the one or more RS resources for measurement;
the transceiver and the processor are configured to perform measurements of the one or more RS resources for validity;
the processor is configured to determine one or more best RS resources of the one or more RS resources for validity based on the measurements of the one or more RS resources for validity;
the processor is configured to determine, on a condition that at least one RS resource from the prediction of the one or more best RS resources of the one or more RS resources for prediction corresponds to an RS resource of the one or more best RS resources of the one or more RS resources for validity, that the prediction of the one or more best RS resources of the one or more RS resources for prediction is a valid prediction; and
the transceiver and the processor are configured to report the determination that the prediction of the one or more best RS resources of the one or more RS resources for prediction is a valid prediction.

36. The WTRU of claim 11, wherein the determination that the prediction of the one or more best RS resources of the one or more RS resources for prediction is a valid prediction is performed over a preconfigured time period.

37. The WTRU of claim 11, wherein the one or more RS resources for measurement are one or more RS resources for channel measurement.

38. The WTRU of claim 11, wherein the one or more RS resources for validity are one or more RS resources for prediction accuracy.

39. The WTRU of claim 11, wherein the one or more RS resources for measurement are one or more beam RS resources for measurement, the one or more RS resources for prediction are the one or more beam RS resources for prediction, and the one or more RS resources for validity are the one or more beam RS resources for validity.

40. The WTRU of claim 11, wherein the transceiver and the processor are further configured to report up to a configured number of RS resources from the prediction of the one or more best RS resources of the one or more RS resources for prediction.

41. The WTRU of claim 11, wherein the one or more RS resources for measurement are in a first frequency range, and the one or more RS resources for prediction are in a second frequency range.

42. The WTRU of claim 11, wherein the transceiver and the processor are further configured to receive information providing a correspondence between the one or more RS resources for prediction and the one or more RS resources for validity.

43. The WTRU of claim 11, wherein the one or more best RS resources of the one or more RS resources for prediction have a highest reference signal received power (RSRP) from among the one or more RS resources for prediction.

44. The WTRU of claim 11, wherein the one or more best RS resources of the one or more RS resources for validity have a highest RSRP from among the one or more RS resources for validity.
